(19) United States
(12) Patent Application Publication
(10) Pub. No.: US 2008/0075921 A1
(43) Pub. Date: Mar. 27, 2008

(54) Transfer material for electronic device, method of forming insulating layer and partition wall of electronic device, and light-emitting element

(75) Inventor: Tomomi Tateishi, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,031

(22) Filed: Sep. 18, 2007

(30) Foreign Application Priority Data
Sep. 27, 2006 (JP) 2006-263437

(51) Int. Cl. B32B 3/00; B44C 1/165

(52) U.S. Cl. 428/141; 156/230; 428/172

(57) ABSTRACT

The present invention provides a transfer material for an electronic device that includes a transfer support and, provided on the support in this order, an insulating layer or a partition wall material layer, and a layer containing an organic low-molecular-weight compound having charge transportability; a method of forming an insulating layer and a partition wall of an electronic device using the transfer material; and a light-emitting element.

### CROSS-REFERENCE TO RELATED APPLICATION

This application claims priority under 35 USC 119 from Japanese Patent Application No. 2006-263437, the disclosure of which is incorporated by reference herein.

### BACKGROUND OF THE INVENTION

1. Field of the Invention

The present invention relates to a transfer material that is used to form an insulating layer or a partition wall in an electronic device, such as a light-emitting element, to a method of forming an insulating layer or a partition wall of an electronic device using the transfer material, and to a light-emitting element that is manufactured using the method.

2. Description of the Related Art

Conventionally, when manufacturing a light-emitting element, an insulating layer or a partition wall is formed by various methods. When electrodes formed of ITO are patterned, defective luminescence of the light-emitting element may occur at an end (edge) of the pattern due to irregularity in thickness or shape, inclination, or swelling. For example, when the edge has low resistance, only the edge emits light. Further, when the edge has an uneven shape, an organic compound layer may be cracked and the electrodes may be connected with each other. As a result, current may not flow in the organic light-emitting layer. The insulating layer is a uniform layer having high resistance that is formed at an edge portion to prevent defective luminescence.

Conventionally, a method of forming an insulating layer is known, whereby: first, ITO electrodes are patterned on a substrate; next, an inorganic oxide layer is formed on the entire surface of the substrate on which the ITO electrodes are formed, using an inorganic oxide, such as SiO₂; and, then, the inorganic oxide layer is etched and patterned using photolithography, thereby forming the insulating layer. However, in the known method of forming an insulating layer, since a special solution for etching is used, the substrate may be damaged. In particular, when a film, rather than glass, is used as the material of the substrate on which the ITO electrodes are formed, the substrate may be heavily damaged. At worst, the substrate may be deformed and, as a result, a desired pattern cannot be obtained.

A partition wall is a part of the element that is required when a passive driving mode is used as a driving mode of the light-emitting element. In the conventional method of forming a partition wall, first, ITO electrodes are patterned, and then an insulating layer is patterned. Subsequently, a partition wall material is coated on the entire surface of the substrate on which the ITO electrodes are formed. Next, the partition wall material is etched to form a pattern using photolithography, and then the pattern is subjected to a high-temperature treatment, thereby forming the partition wall. However, in the method of forming a partition wall, the substrate may also be damaged due to the use of a special solution for etching or a high-temperature treatment when the partition wall is formed.

A method that uses a transfer material to form the insulating layer or the partition wall is known (for example, see Japanese Patent Application Laid-Open (JP-A) No. 2001-196186, Japanese National Phase Publication No. 2006-505111, and JP-A Nos. 2001-210469, 2001-250693, 2002-139613, 2002-139614, 2003-264069, and 2005-310404). According to this method, the insulating layer or the partition wall can be formed without using a solvent-resistant or heat-resistant substrate. Further, the process can be simplified as compared with a process of forming an insulating layer or a partition wall using photolithography. However, as described in the above-described documents, an insulating layer or a partition wall, which is formed by transfer using the transfer material, has poor adhesiveness to a transfer surface and may become separated therefrom. In particular, when an insulating layer or a partition wall formed of a polymer material is formed using a transfer material, deterioration in adhesiveness to the substrate becomes especially pronounced.

As described above, a technology that can simply form an insulating layer or a partition wall having high adhesiveness to the substrate is increasingly required, but such a technology has not yet been provided.

### SUMMARY OF THE INVENTION

The present invention has been made in consideration of the above-described circumstances. A first aspect of the invention is to provide a transfer material for an electronic device including, a transfer support and, provided on or above the support in this order, an insulating layer or a partition wall material layer, and a layer containing an organic low-molecular-weight compound having charge transportability

A second aspect of the invention is to provide a method of forming an insulating layer of an electronic device. The method includes the processes of preparing a transfer material for an electronic device that includes a transfer support and, provided on or above the transfer support in this order, an insulating layer and a layer containing an organic low-molecular-weight compound having charge transportability, and laminating the transfer material on a transfer substrate such that the layer containing the organic low-molecular-weight compound having charge transportability in the transfer material for an electronic device faces a surface of the transfer substrate on which an electrode is provided partially or entirely, then heating and pressing, and subsequently removing the transfer support to transfer the insulating layer to the surface of the transfer substrate on which the electrode is provided, thereby forming an insulating layer on the transfer substrate.

A third aspect of the invention is to provide a method of forming a partition wall of an electronic device. The method includes the processes of preparing a transfer material for an electronic device that includes a transfer support and, provided on or above the transfer support in this order, a partition wall material layer and a layer containing an organic low-molecular-weight compound having charge transportability, and laminating the transfer material on a transfer substrate such that the layer containing the organic low-molecular-weight compound having charge transportability in the transfer material for an electronic device faces a surface of the transfer substrate on which an electrode is provided partially or entirely, then heating and pressing, and subsequently removing the transfer support to transfer the partition wall material layer to the surface of the transfer substrate on which the electrode is provided, thereby forming a partition wall on the transfer substrate.

A fourth aspect of the invention is to provide a light-emitting element that includes an insulating layer formed using the method of forming an insulating layer of an electronic device.

A fifth aspect of the-invention is to provide a light-emitting element that includes a partition wall formed using the method of forming a partition wall of an electronic device.

### BRIEF DESCRIPTION OF THE DRAWINGS

FIG. 1 is a process flow showing an example of forming an insulating layer by a method of forming an insulating layer according to an embodiment of the present invention;

FIG. 2A is a schematic cross-sectional view showing a transfer substrate that is used in an embodiment of the invention, which shows a state where only an electrode is formed on the substrate;

FIG. 2B is a schematic cross-sectional view showing a transfer substrate that is used in an aspect of the invention, which shows a state where an electrode and an organic low-molecular-weight compound layer are formed on the substrate;

FIGS. 3A and 3B are schematic partial cross-sectional views showing an example of a transfer substrate, on which an insulating layer is formed by a method of forming an insulating layer according to an embodiment of the invention;

FIGS. 4A and 4B are schematic partial cross-sectional views showing an example of a transfer substrate, on which an insulating layer is formed by a method of forming an insulating layer according to an embodiment of the invention;

FIG. 5 is a process flow showing an example of forming a partition wall by a method of forming a partition wall according to an embodiment of the invention;

FIGS. 6A and 6B are schematic partial cross-sectional views showing an example of a transfer substrate after a partition wall is formed by a method of forming a partition wall according to an embodiment of the invention; and

FIG. 7 is a side view showing a liquid droplet formed on a transfer support.

### DETAILED DESCRIPTION OF THE INVENTION

Hereinafter, a transfer material for an electronic device, a method of forming an insulating layer or a partition wall of an electronic device using the transfer material, and a light-emitting element according to the present invention will be described in detail. In the present specification “ . . . to . . . ” represents a range including the numeral values represented before and after “to” as a minimum value and a maximum value, respectively.

The electronic device used herein, as a component, includes an insulating layer and/or a partition wall that is formed using a transfer material according to the invention. As a representative example of the electronic device, an electroluminescent element, such as an organic electroluminescent element, is exemplified. However, the invention is not limited thereto.

### [1] Transfer Material for Electronic Device

### (1) Configuration

A transfer material for an electronic device of the invention (hereinafter, simply referred to as “transfer material of the invention”) includes, i transfer support, and provided in this order, an insulating layer or a partition wall material layer, and a layer containing a organic low-molecular-weight compound having charge transportability (Hereinafter, the organic low-molecular-weight compound having charge transportability may also be simply referred to as “organic low-molecular-weight compound”, and the layer containing the same may also be referred to as “organic low-molecular-weight compound layer”).

The transfer material of the invention can be appropriately used to form an insulating layer or a partition wall in an electronic device, for example, an electroluminescent element, such as an organic electroluminescent element.

The transfer material of the invention is characterized by having an organic low-molecular-weight compound layer, which is interposed between a transfer substrate and an insulating layer or a partition wall when the insulating layer or the partition wall is formed on the transfer substrate. It is thought that, with the organic low-molecular-weight compound layer, the adhesiveness to the transfer surface of the insulating layer or the partition wall, which is formed of the transfer material of the invention, is improved. Accordingly, an insulating layer or a partition wall having high adhesiveness to the transfer surface can be simply formed using the transfer material of the invention.

When the insulating layer and the partition wall are formed using the transfer material of the invention, an etching process or the like is not required. Therefore, deterioration of an electrode (for example, an ITO electrode) formed on transfer substrate when the insulating layer and the partition wall are formed can be effectively suppressed.

The transfer material of the invention necessarily includes a transfer support and, provided on or above the transfer support in this order, an insulating layer or a partition wall material layer, and a layer containing the organic low-molecular-weight compound having charge transportability. In addition to these layers, the transfer material of the invention may include an additional layer if necessary. Examples of the additional layer include a release layer and the like.

### (2) Organic Low-Molecular-Weight Compound Layer

In the invention, the organic low-molecular-weight compound layer contains at least one organic low-molecular-weight compound having charge transportability.

The organic low-molecular-weight compound used therein is not particularly limited. Any compound can be used as long as it has a function to inject an electron from a cathode, a function to transport an electron, or a function to block a hole injected from an anode in a light-emitting element, which is manufactured according to the invention. Specific examples of the organic low-molecular-weight compound include triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic acid anhydrides including naphthalene and perylene, phthalocyanine derivatives, metal complexes including 8-quinolinol derivatives, metallophthalocyanine, metal complexes having benzoxazole or benzothiazole as a ligand, conductive polymers including aniline copolymers, thiophene oligomers, polythiophene, polythiophene derivatives, polyphenylene derivatives, polyphenylene vinylene derivatives, polyfluorene derivatives.

The organic low-molecular-weight compound can be appropriately selected according to the material, shape, and the like of the transfer surface. For example, a compound that is the same as the organic low-molecular-weight compounds having charge transportability in the light-emitting elements and the like described below that are manufactured using the transfer material of the invention, or a compound having a similar structure, is preferably used. A “similar structure” here means that the steric structure of the compound is similar, or that a physical value, which is calculated from a structure and which is known as the logP value, the presence or absence value, or the SP value, of the compound is similar.

The organic low-molecular-weight compound layer may contain components other than organic low-molecular-weight compound (for example, a component that suppresses moisture or oxygen, which deteriorates the light-emitting element, from entering or permeating the light-emitting element, or a component that is used for a protective layer or a sealing layer in the light-emitting element described below), if necessary.

Examples of the component that suppresses moisture or oxygen, which deteriorates the light-emitting element, from entering or permeating the light-emitting element include silicon monoxides, silicon dioxides, germanium monoxides, germanium dioxides, copolymers of tetrafluoroethylene and at least one comonomer, fluorine-containing copolymers having a cyclic structure in the copolymerization main chain, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene or dichlorodifluoroethylene and comonomers, water-absorbent materials having a water absorption coefficient of 1% or more, moisture-proof materials having a water absorption coefficient of 0.1% or less, metals (such as In, Sn, Pb, Au, Cu, Ag, Al, Ti, and Ni), metal oxides (such as MgO, SiO, SiO₂, Al₂O₃, GeO, NiO, CaO, BaO, Fe₂O₃, Y₂O₃, and TiO₂), metal fluorides (such as MgF₂, LiF, AlF₃, and CaF₂), liquid fluorinated carbon (such as perfluoroalkane, perfluoroamine, and perfluoroether), and materials obtained by dispersing a moisture or oxygen absorbing agent in liquid fluorinated carbon.

The content of the organic low-molecular-weight compound in the organic low-molecular-weight compound layer, is preferably 10 parts by mass or more, more preferably 20 parts by mass or more, and further preferably 50 parts by mass or more with respect to a component 100 parts by mass forming the organic low-molecular-weight compound layer.

The organic low-molecular-weight compound preferably has enough thickness to uniformly form a film on the surface in view of adhesiveness of the insulating layer or the partition wall to be formed to the transfer surface. Generally, the thickness is preferably 1 nm or more, more preferably from 5 nm or more, and further preferably from 10 nm or more.

The organic low-molecular-weight compound layer can be formed on the insulating layer or the partition wall material layer described below using a vacuum deposition method, a sputtering method, a reactive sputtering method, a molecular beam epitaxial method, an ionized cluster beam method, an ion plating method, a plasma polymerization method, a plasma CVD method, a laser CVD method, a thermal CVD method, or a coating method.

### (3) Insulating Layer or Partition Wall Material Layer

### (3-1) Insulating Layer

An insulating layer in the transfer material of the invention is a layer that contains at least one insulating material. Performing a transfer to a surface to be transferred of a transfer substrate by using the transfer material, the insulating layer of the electronic device can be formed.

In the invention, the “insulating layer” indicates a portion that covers the end of the patterned anode in the electronic device.

The insulating material that can be applied to the insulating layer preferably has resistance value of 10³ Ω/sq. or more, and more preferably 10⁵ Ω/sq. When resistance is less than 10³ Ω/sq., the insulating layer may be electrically connected to the electrode. In order to obtain an excellent insulation property, the insulating material preferably has different resistance from the electrode. A difference in resistance is preferably 10² Ω/sq. or more, and more preferably 10⁴ Ω/sq. or more. In addition, the insulating layer is preferably formed of a material that has the least amount of change in shape or characteristic while heating. Specifically, an organic material, such as a UV curable resin material including a photocurable acrylic resin, a methallyl resin, or a novolac resin, polyimide resin including a photosensitive polyimide resin, or a thermosetting resin, an inorganic material, an oxide of an inorganic substance, or a mixture of inorganic substance and high-molecular-weight material can be used. The insulating layer may contain a known coloring material, if necessary, in addition to the insulating material.

The insulating layer may be colorless and transparent, colored and transparent, or nontransparent. For extracting luminescence, the insulating layer may be colored to such an extent that luminescence from different locations does not mix. The transmittance is preferably 60% or less, and more preferably 70% or less. The transmittance can be measured by a known method using a spectrophotometer.

The insulating layer preferably has enough thickness to cover the patterned portion of the electrode. Generally, the insulating layer is preferably 2 to 20 times thicker than the electrode, and more preferably 5 to 15 times. When photoresist is used, the insulating layer is generally provided to have a thickness of 0.5 μm to 2 μm.

As a method of forming the insulating layer, a general method, such as a photolithography method or a printing method, can be used. Specifically, a material obtained by solving resist, such as acryl resin or polyimide resin, in a solvent, is coated by various coating methods, such as a spin coating method, a dip coating method, to thereby form an organic layer. Subsequently, the organic layer is patterned using a photolithography technology or an etching technology, thereby forming the insulating layer.

### (3-2) Partition Wall Material Layer

The partition wall material layer in the transfer material of the invention contains at least one insulating material. Performing a transfer to a surface to be transferred of a transfer substrate by using the transfer material, the partition wall material layer of the electronic device can be formed.

In the invention, the “partition wall” is formed when the electronic device is driven in a passive driving mode, and divides an upper electrode into lines. For example, the partition wall layers are formed in an inverse tapered shape between the lower electrode and the upper electrode, and the partition wall layers are arranged in parallel. The upper electrode lines are separated from each other by the partition wall.

The partition wall material layer may be a layer having an insulation property or a layer not having an insulation property. When the partition wall material layer is formed as a layer having an insulating property, the partition wall can be formed using the same material as the insulating material that can be applied to the insulating layer. Thereby, productivity can be improved.

As a partition wall material that can be applied to the partition wall material layer, the materials that are exemplified as the insulating material for the insulating layer can be used. Specifically, photosensitive resin, such as polyimide, is deposited, and then exposure or development is performed using a photomaps, thereby forming the partition wall.

The partition wall material layer may contain a moisture absorbing agent, an inert liquid, a getter, a coloring material, or the like, if necessary, in addition to the partition wall material. In addition, if necessary, a plasticizer, an antioxidant, a filler, and the like can be added.

Examples of the moisture absorbing agent include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, magnesium oxide, and the like. Examples of the inert liquid include paraffins, liquid paraffins, fluorine solvents (perfluoroalkane, perfluoroamine, and perfluoroether), chlorine solvents, and silicon oils.

As the getter, a commercial product can be used. For example, GOD/CAI/RIT-F (manufactured by Saes Getters Co., Ltd.) can be used.

As the coloring material, any coloring material that is classified into ink composition can be used. For example, known inorganic or organic dyes or pigments, such as water-based pigment ink, which is used as printing ink, stamp ink, ballpoint ink, or water-based writing ink, water-based dye ink, oily pigment ink, and oily dye ink coating materials, can be used. However, the invention is not necessarily limited thereto.

As the pigment or dye pigment, for example, an inorganic pigment, such as metal powder, is exemplified. Specific examples include titanium oxide, mica, iron black, carbon black, iron blue, ultramarine, blue 1, red iron oxide, ferric sulfate, chromium oxide, chromium hydroxide, zinc oxide, zirconium oxide, cobalt oxide, fish scale flake, bismuth oxychloride, titanated mica, Blue 2, Blue 404, Red 2, Red 3, Red 102, Red 104, Red 105, Red 106, Yellow 4, Yellow 5, and Green 3.

As the dye, organic dyes, such as an azo pigment, a phthalocyanine pigment, a quinacridone pigment, an anthraquinone pigment, and a dioxazine pigment, can be exemplified. Specific examples of an oil-soluble pigment include Sudan red, DC Red 17, DC Green 6, β-carotene, soybean oil, Sudan brown, DC Yellow 11, DC Violet 2, DC Orange 5, quinoline yellow, annatto, carotenoid derivatives, such as lycopene, β-carotene, bixin, and capsanthin, Disazo Yellow, Brilliant Carmin 6B, Lake Red C, Phthalocyanine Blue, Kayaset Black KR, Kayaset Red K-BE, Kayaset blue KFL (trade names, manufactured by Nippon Kayaku Co., Ltd.), Oil Yellow 3G, Oil Color Yellow #105, Orange #201, Pink #312, Scarlet #308, Red #330, Brown #416, Green BG, Violet #730 (trade names, manufactured by Orient Kagaku Co., Ltd.), Red 5B 02, Blue B 01, Brown B (trade names, manufactured by Clariant Japan Co., Ltd.), and a mixture thereof. Examples of a water-soluble dye include copper sulfate, ferric sulfate, water-soluble sulfopolyester, rhodamine, natural pigments (carotene, beet pulp), methylene blue, and caramel. The colorants may be used alone or in combination of two or more. The blending amount of the colorant varies according to the purpose. Generally, the blending amount of the colorant is in a range of 0.01 to 5% by mass such that the color can be visually recognized.

The thickness of the partition wall material layer is not particularly limited as long as the partition wall formed using the transfer material of the invention can electrically insulate the upper electrode. The thickness of the partition wall material layer is preferably from 1 μm to 100 μm, and more preferably from 2 μm to 10 μm.

A method of forming the partition wall material layer is not particularly limited as long as a predetermined pattern can be formed. A known photolithography method, a printing method, such as a gravure method, a flexography method, or a screen method, an ink jet method, or a nozzle coating method may be used. For example, when the partition wall material layer is formed using a photolithography method, photosensitive resin, which is a material for forming the partition wall material layer, is coated on the substrate using a predetermined method, such as spin coat, spray coat, roll coat, die coat, or dip coat, to the height of the partition wall material layer, to thereby form a resin film. Then, masking is performed according to the planar pattern (wiring pattern) of the partition wall material layer, and the resin film is subjected to exposure and development. As a result, the partition wall material layer is provided upright on the transfer support.

The partition wall that is formed using the transfer material of the invention may extend in a direction perpendicular to the surface of the substrate to form a groove. Preferably, the partition wall is provided upright on the substrate in an inverse tapered shape such that the electrodes are easily separated.

### (4) Transfer Support

In the invention, the transfer support is not particularly limited as long as it is a support that can be applied to the transfer material. Examples of the transfer support include a support (hereinafter, sometimes referred to as “temporary support”) that is chemically and thermally stable and is flexible and a support (hereinafter, sometimes referred to as “pressing member” that is not flexible and can uniformly press the entire surface of the transfer surface.

The pressing member may be transparent or nontransparent as long as it can uniformly press the entire surface to be transferred of the transfer surface. However, when position adjustment is performed from the pressing member side, a colorless and transparent pressing member is preferably used to suppress scattering and attenuation.

A material for the pressing member is not particularly limited as long as a required property is satisfied. Specific examples of the material for the pressing member include sheets of inorganic materials, such as yttrium-stabilized zirconia (YSZ) and glass, metal foils formed of aluminum, copper, stainless steel, gold, and silver, polyimide, sheets of plastics, such as liquid crystal polymers, fluorine resin (for example, tetrafluoroethylene resin (PTFE), trifluorochloroethylene resin (PCTFE)), polyethylene naphthalate (PEN), polycarbonate, polyether sulfone (PES), and rigid polyvinyl chloride, and laminates thereof. Among them, in view of workability and cost, a glass plate, a stainless steel foil, a polyimide sheet, or a polycarbonate sheet is preferably used.

The structure and size of the pressing member are not particularly limited, and can be appropriately selected according to the specification of manufacturing equipment and the purposes. The thickness of the pressing member can be appropriately selected according to the specification of manufacturing equipment. The shape of the pressing member is preferably a roll, a plate, or a sheet. The pressing member is not particularly limited, but it is preferably a convex plate that has a convex patterned portion and an unpatterned portion recessed from the patterned portion. Here, the “patterned portion” refers to a portion that is patterned to correspond to the shape of the insulating layer or the partition wall formed using the transfer material of the invention, and the “unpatterned portion” refers to a portion other than the patterned portion.

The temporary support is formed of a material that is chemically and thermally stable and is flexible. Specific examples of the temporary support include thin sheets of materials, such as fluorine resin (for example, tetrafluoroethylene resin (PTFE), trifluorochloroethylene resin (PCTFE)), polyester (for example, polyethylene terephthalate (PET), polyethylene naphthalate (PEN)), polyarylate, polycarbonate, polyolefin (for example, polyethylene and polypropylene), and polyether sulfone (PES), and laminates thereof. More preferably, polyester (PET or the like) or polyether sulfone is preferably used.

The resin for the temporary support may have a reactive group, such as a hydroxyl group, a carboxyl group, an amino group, an epoxy group, an acryl group, and a methacryl group. The thickness of the temporary support is preferably from 1 μm to 300 μm, more preferably from 3 μm to 200 μm, and further preferably from 5 μm to 150 μm.

The temporary support may be a monolayer or a laminate.

A surface of the transfer support on which the insulating layer or the partition wall material layer is provided (hereinafter, sometimes referred to as “transfer support surface”) preferably has a contact angle of 500 or more with respect to pure water in view of releasability between the transfer support and the insulating layer or the partition wall material layer. The contact angle is preferably 60° or more, and more preferably 70° or more.

The contact angle of the transfer support surface to pure water is defined by an angle between the transfer support surface and a tangent to the surface of a droplet at a contact point of the transfer support surface and pure water.

A method of measuring the contact angle is not particularly limited as long as it is performed using a general contact angle meter, which measures the still droplet immediately after dropping. Specifically, the contact angle can be measured by a contact angle meter type CA-X, manufactured by Kyowa Interface Science Co., Ltd. The measurement is preferably performed under a predetermined condition of a temperature of 21 to 24° C. and relative humidity of 45 to 55%.

When the insulating layer or the partition wall material layer is provided on the transfer support by a coating method, in view of preventing liquid irregularity, the contact angle is preferably 90° or less. When the insulating layer or the partition wall material layer is provided by a dry method, such as a vacuum film deposition method or a transfer and release method, the above-described problem does not occur, and the contact angle is not particularly limited.

FIG. 7 is a side view of a liquid droplet that is formed on the transfer support surface. In order to calculate the contact angle θ, a line 106 is drawn from an apex 103 of a liquid droplet 102 dropping on the transfer support surface 101 to a contact point 105 between the plate and pure water, and an angle α between the line 106 and the transfer support surface 101 is measured. The contact angle θthat is an angle between the plate and the tangent 104 of the liquid droplet 102 is two times more than α.

In order to set the contact angle to 50° or more on the transfer support surface, a surface treatment (water repellent treatment) is preferably performed on the transfer support surface.

The surface treatment may be performed at least on the transfer support surface. As a method for the surface treatment (water repellent treatment), a fluorination treatment, a corona discharge treatment, a plasma treatment, an ozonation treatment, flame treatment, and a glow discharge treatment can be exemplified. Examples of the fluorination treatment include a plasma treatment that uses fluorocarbon gas (CF₄ gas and the like), and a method that exposes vapor of an alkyl fluoride coupling agent (for example, perfluoroalkly-functionlized silane, and preferably perfluoroalkly trimethoxysilane).

Prior to the water repellent treatment, an undercoat layer may be provided on the transfer support surface. With the undercoat layer, a water repellent effect of the surface can be improved.

In view of flatness and uniform quality of the insulating layer and the partition wall material layer on the transfer support, when the thickness of the organic low-molecular-weight compound layer is set at 100, the maximum surface roughness Rₘₐₓ Of the transfer support surface defined by Japanese Industrial Standard (JIS) B 0601-1982, the content of which is incorporated by reference therein, is preferably from 0 to 50, more preferably from 0 to 25, and further preferably from 1 to 10.

In setting the maximum surface roughness Rₘₐₓ of the transfer support surface to the above-described range, a planarizing layer may be provided on the surface when the support has a rough surface, or polishing or a heat treatment may be performed to planarize the surface.

As a method of measuring the maximum surface roughness Rₘₐₓ, an atomic force microscopy method, a confocal microscopy method, a stylus method, an optical microscopic interference method, a multiple interference method, and a light-section method can be exemplified. Of these, the atomic force microscopy method and the confocal microscopy method are preferably used.

### Release Layer

The transfer support may have a release layer on the transfer support surface. The release layer preferably contains a component having a releasing effect (releasing agent). The releasing effect means that, when the transfer material is laminated on a surface to be transferred of the transfer surface, and heated and pressed, and then the transfer support is released, the insulating layer or the partition wall material layer is efficiently transferred to the surface without being welded to the transfer support.

The thickness of the release layer is preferably from 0.5 nm to 50 μm in view of an enough releasing effect.

Examples of a material for the release layer include polyolefin resin, such as polyethylene and polypropylene, vinyl resin, such as polyvinyl chloride, polyvinylidene chloride, polyvinyl acetate, copolymers of vinyl chloride or vinyl acetate, polyacrylic acid ester, and polystyrene, polyester resin, such as polyethylene terephthalate and polybutylene terephthalate, polyamide resin, such as copolymers of olefin, for example, ethylene and propylene, and other vinyl monomers, ionomers, cellulose resin, such as ethylcellulose and cellulose acetate, polycarbonate resin, and phenoxy resin. Of these, vinyl resin and polyester resin are preferably used. These resine may be used alone or in combination of two or more.

The release layer may contain a releasing agent. Examples of the releasing agent include silicon-containing compounds, fluorine-containing compounds, waxes, inorganic fillers, organic fillers, surfactants, and metal soaps. As the silicon-containing compound, at least one selected from a group consisting of silane compound, silicon oil, silicon rubber, and silicon resin is preferably used. As the fluorine-containing compound, at least one selected from a group consisting of fluorine surfactant, fluorine oil, fluorine rubber, and fluorine resin is preferably used. These releasing agents may be used alone or in combination of two or more.

The release layer may have a functional group that reacts resin for the transfer support surface and/or the release layer. For example, when resin having a reactive group, such as a hydroxyl group, a carboxyl group, an amino group, an epoxy group, an acryl group, or a methacryl group, is used as the resin for the transfer support and/or the release layer, and a silicon-containing compound or a fluorine-containing compound having a functional group, such as a carboxyl group, a hydroxyl group, an amino group, an epoxy group, or an isocyanate group reacts with the end of the reactive group, the release layer can be fixed to the transfer support.

Alternatively, resin having a reactive group, such as a hydroxyl group, a carboxyl group, an amino group, an epoxy group, an acryl group, or a methacryl group may be used as the resin for the release layer, and a reaction may be performed in the release layer using the silicon-containing compound or the fluorine-containing compound having the above-described functional group. With cross-linkage in the release layer, the release layer can be cured and the releasing effect can be increased. The releasing agent having the functional group may react with the surface of the plate and the resin for the release layer.

The reactive group (a hydrophilic group, such as a hydroxyl group) of the transfer support surface may be formed by an activation treatment, such as a corona discharge treatment, a plasma treatment, an ozonation treatment, a flame treatment, a glow discharge treatment. The reaction of the releasing agent having the functional group and the resin for the transfer support surface and/or the release layer can be performed by heat, light, or the like. Accordingly, after the release layer is formed on the transfer support, the reaction can be performed by a heating and drying process.

Examples of the releasing agent having the functional group include modified silicon oil, such as epoxy modification, vinyl modification, alkyl modification, amino modification, carboxyl modification, alcohol modification, fluorine modification, alkylaralkyl polyether modification, epoxy/polyether modification, and polyether modification, modified silicon resin, modified fluorine resin, and modified fluorine rubber.

As the releasing agent that can be applied to the release layer, those described in the paragraphs [0047] to [0079] of JP-A No. 2005-78942 can be exemplified.

In view of the quality of the release layer and the transfer rate, the addition amount of the releasing agent is preferably from 0.01 to 50% by mass with respect to resins forming the release layer, and more preferably from 0.1 to 40% by mass.

The release layer may contain other components to such a degree not to detract the advantages of the invention.

The release layer is preferably formed by a wet method. That is, a material for the release layer is dissolved at a desired concentration in an organic solvent, and the resultant solution is coated on the plate. The coating method is not particularly limited as long as uniform film distribution can be obtained. For example, a spin coating method, a gravure coating method, a dip coating method, a casting method, a die coating method, a roll coating method, a bar coating method, an extrusion coating method, and an ink jet coating method can be exemplified.

### [2] Method of Forming Insulating Layer of Electronic Device

A method of forming an insulating layer of an electronic device of the invention (hereinafter, also simply referred to as “insulating layer forming method”) includes the processes of preparing a transfer material for an electronic device that includes a transfer support and, provided on or above the transfer support in this order, an insulating layer and a layer containing a organic low-molecular-weight compound having charge transportability, and laminating the transfer material on the transfer substrate such that the charge transporting organic compound layer in the transfer material for an electronic device faces a surface of the transfer substrate, on which an electrode is provided partially or entirely, then heating and pressing, and subsequently removing the transfer support to transfer the insulating layer to the surface of the transfer substrate, on which the electrode is provided, thereby forming an insulating layer on the transfer substrate.

A method of forming an insulating layer of the invention will be described with reference to the drawings.

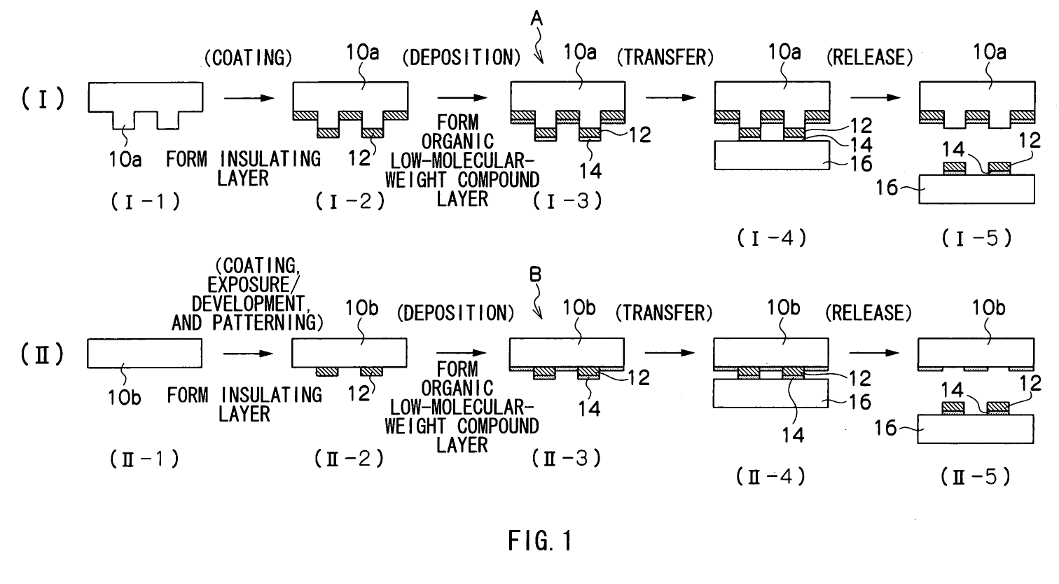

FIG. 1 is a process flow showing an exemplary embodiment of forming an insulating layer according to the method of forming an insulating layer of the present the invention.

In FIG. 1, (I) is a process flow showing an exemplary embodiment of forming an insulating layer using a transfer material A, which includes a pressing member 10a having a convex portion as a transfer support (hereinafter, referred to as “process flow (I)”).

In the process flow (I), as shown in (I-1) to (I-3), a coating liquid for an insulating layer 12 is coated on a surface of the pressing member 10a having the convex portion to form the insulating layer 12. Then, an organic low-molecular-weight compound layer 14 is formed on the insulating layer 12 by deposition, thereby manufacturing the transfer material A using the pressing member 10a. In addition, as shown in (I-4) to (I-5), the transfer material A is laminated on a transfer substrate 16 such that the organic low-molecular-weight compound layer 14 in the transfer material A faces a surface of the transfer substrate 16, on which an electrode (not shown) is provided, and then heated and/or pressed. Subsequently, the pressing member 10a is removed, and then the insulating layer 12 is transferred to the transfer substrate 16 via the organic low-molecular-weight compound layer 14. The transferred insulating layer 12 serves as an insulating layer in an electronic device, which is manufactured using the transfer substrate 16 after the transfer is completed.

In FIG. 1, (II) is a flow showing an exemplary embodiment of forming an insulating layer using a transfer material B, which has a flat plate-shaped temporary support 10b as a transfer support (hereinafter, referred to as “process flow (II)”).

In the process flow (II), as shown in (II-1) to (II-3), a coating liquid for an insulating layer 12 is coated, developed, and patterned (coating, development, and patterning are not shown) to form the insulating layer 12 on the temporary support 10b. Then, an organic low-molecular-weight compound layer 14 is formed on the insulating layer 12 by deposition, thereby manufacturing the transfer material B using the temporary support 10b. In addition, as shown in (II-4) to (II-5), the transfer material B is laminated on the transfer substrate 16 such that the organic low-molecular-weight compound layer 14 in the transfer material B faces a surface of the transfer substrate 16, on which an electrode (not shown) is provided, and then heated and/or pressed. Subsequently, the temporary support 10b is removed, and then the insulating layer 12 is transferred to the transfer substrate 16 via the organic low-molecular-weight compound layer 14. The transferred insulating layer 12 functions as an insulating layer in an electronic device, which is manufactured using the transfer substrate 16 after the transfer is completed.

In the transfer substrate that can be applied to the invention, an electrode is formed partially or entirely thereon. The transfer substrate may include a substrate and an electrode, or may have an additional organic low-molecular-weight compound layer on the electrode. When the additional organic low-molecular-weight compound layer is provided on the electrode, adhesiveness of an insulating layer to be formed (an insulating layer in an electronic device) and the transfer substrate can be improved.

As a material that can be used for the organic low-molecular-weight compound layer, the materials that are described for the organic low-molecular-weight compound layer in the transfer material of the invention can be applied. In view of adhesiveness, the organic low-molecular-weight compound layer in the transfer material and the organic low-molecular-weight compound layer of the transfer substrate preferably have the same composition.

The substrate in the transfer substrate is not particularly limited as long as it can be applied to an electronic device, such as a light-emitting element. For the detailed description of the material and shape of the substrate, the same description of a light-emitting element described below can be applied.

The electrode that is provided on the transfer substrate may be an anode or a cathode. An electrode to be provided is determined according to the configuration of the electronic device. For the detailed description of the material and shape of the electrode and a method of forming an electrode, the same description of a light-emitting element described below can be applied.

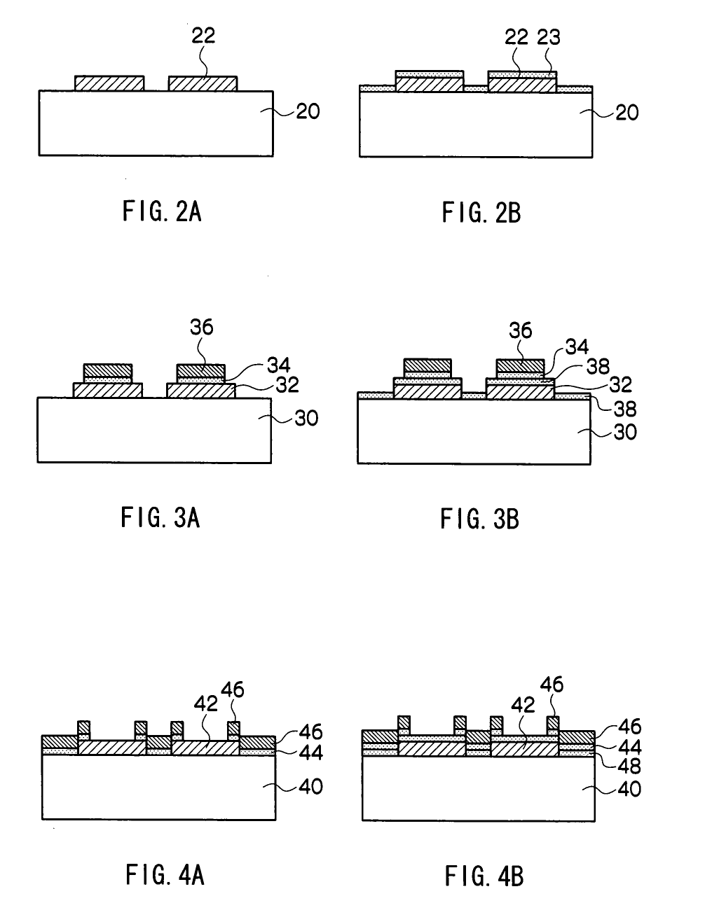

FIGS. 2A and 2B are schematic partial cross-sectional views showing examples of the configuration of a transfer substrate that can be used in the invention. FIG. 2A shows a state where only an electrode 2 is formed on a substrate 1. FIG. 2B shows a state where an electrode 2 is formed on a substrate 1, and an organic low-molecular-weight compound layer 3 is formed.

Various formation conditions in the insulating layer forming method of the invention will now be described in detail. A temperature when the insulating layer is transferred to the transfer substrate is not particularly limited, but it changes according to the material of the insulating layer or a heating member. Generally, the temperature is preferably from 40 to 250° C., more preferably from 50 to 200° C., and further preferably from 60 to 180° C. However, a preferable temperature range during the transfer has relation to heat resistance of the heating member, the transfer material, and the transfer substrate. As the heat resistance is improved, the temperature range changes accordingly. Accordingly, when two or more transfer materials are used, the transfer temperature of a transfer material that is initially transferred is preferably higher than the transfer temperature of a transfer material that is subsequently transferred. Further, when a transfer material having two or more insulating layers is used, the transfer temperature of an organic compound layer that is initially transferred is preferably higher than the transfer temperature of an organic compound layer that is subsequently transferred.

A pressure when the insulating layer is transferred to the transfer substrate is not particularly limited, but it changes according to the material of the insulating layer or the pressing member. Generally, the pressure is preferably from 0 to 10 t/cm², more preferably from 0 to 5 t/cm², and further preferably from 0 to 2 t/cm². However, a preferable pressure range during the transfer has relation to pressure resistance of the pressing member, the transfer material, and the transfer substrate. As the pressure resistance is improved, the pressure range changes accordingly.

A glass transition temperature or a flow initiation temperature of the insulating layer or a high-molecular-weight component is preferably from 40° C. to the transfer temperature+40° C. When two or more transfer materials are used, two or more insulating layers to be transferred may contain at least one common component.

Before the transfer, the transfer substrate and/or the transfer material may be preheated. A preheating temperature of the transfer substrate and/or transfer material is preferably from 30° C. to the transfer temperature+20° C. Further, a temperature when the plate is removed is preferably from −50° C. to the transfer temperature. After the plate is released, the transferred insulating layer may be reheated.

When transfer material is laminated on the substrate such that the insulating layer faces the transfer surface of the transfer substrate, and then heated, pressing may be performed.

When the transfer material is laminated on the substrate such that the insulating layer faces the transfer surface of the transfer substrate, if an approach angle of the transfer material with respect to the substrate is increased, entrainment of air bubbles can be reduced. When the plate is removed from the insulating layer transferred to the substrate, a release angle of the transfer support with respect to the insulating layer is preferably large.

The insulating layer transferred to the transfer substrate or a new insulating layer transferred to the previously transferred insulating layer is preferably reheated and/or re-pressed, if necessary. With reheating and/or re-pressing, the insulating layer is more adhered to the substrate or the previously transferred insulating layer. A temperature during reheating is preferably in a range of the transfer temperature±50° C. A pressure during re-pressing is preferably in a range of the original pressure±100%.

When the transfer is performed two times or more, a surface treatment may be performed to improve adhesiveness to the transfer surface between the first transfer and the second transfer such that a previously transferred layer is inversely transferred to a subsequently transferred layer. As this surface treatment, an activation treatment, such as a corona discharge treatment, a flame treatment, a glow discharge treatment, and a plasma treatment, can be exemplified. If an inverse transfer does not occur when a surface treatment is performed together, the transfer temperature of the previous transfer material may be lower than the transfer temperature of the subsequent transfer material.

The transfer material is preferably repeatedly used to transfer the insulating layer. When the transfer material is repeatedly used, cleaning may be performed each time the transfer material is used or after the transfer material is used multiple times. Cleaning can be performed by a general method, but it is not particularly limited. Preferably, a method that uses a solvent is used such that a predetermined pattern provided on the plate is not damaged. The solvent is not particularly limited, and can be appropriately selected according to the kind of a layer to be provided on the transfer support. Examples of the solvent include halogen solvents, such as chloroform, carbon tetrachloride, dichloromethane, 1,2-dichloroethane, and chlorobenzene, ketone solvents, such as acetone, methyl ethyl ketone, diethyl ketone, N-propyl methyl ketone, and cyclohexanone, aromatic solvents, such as benzene, toluene, and xylene, ester solvents, such as ethyl acetate, N-propyl acetate, N-butyl acetate, methyl propionate, ethyl propionate, γ-butyrolactone, and diethyl carbonate, ether solvents, such as tetrahydrofuran and dioxane, amide solvents, such as dimethylformamide and dimethylacetamide, dimethyl sulfoxide, and water. The solvent may be sprayed and distributed on the plate, or the transfer support may be immersed in the solvent. To promote dissolution into the solvent, an ultrasonic treatment or a heating treatment may be performed.

A manufacturing apparatus that can be applied to form the insulating layer of the invention preferably includes a device that supplies the transfer material having the insulating layer formed on the transfer support by a wet method or the like, a transfer device that presses the transfer material into contact with the transfer surface of the transfer substrate while heating and/or pressing the transfer material, to thereby transfer the insulating layer to the transfer surface of the transfer substrate, and a device that removes the transfer support from the insulating layer after the transfer is completed.

A unit that preheats the transfer material and/or the transfer substrate before the transfer material is supplied to the transfer device is preferably provided. Further, a cooling device may be provided at the back of the transfer device.

An approach angle adjusting unit may be provided in front of the transfer device to increase the approach angle of the transfer material with respect to the transfer substrate. Further, the release angle adjusting unit may be provided at the back of the transfer device or the cooling device to increase a release angle of the transfer support with respect to the insulating layer.

The detailed descriptions of the above-described manufacturing method and apparatus are described in JP-A No. 2002-260854 or Japanese Patent Application No. 2001-089663.

FIGS. 3A to 4B are schematic partial cross-sectional views showing the configuration of the transfer substrate after the insulating layer is formed by the insulating layer forming method of the invention.

FIG. 3A is a diagram showing the configuration of a transfer substrate, which has an electrode 32 provided on a surface of a substrate 30, after an insulating layer 36 is formed on the transfer substrate by the insulating layer forming method of the invention. FIG. 3B is a diagram showing the configuration of a transfer substrate, which has an electrode 32 and an organic low-molecular-weight compound layer 38 sequentially formed on a substrate 30, after the insulating layer 36 is formed on the transfer substrate by the insulating layer forming method of the invention.

FIG. 4A is a diagram showing the configuration of a transfer substrate, which has an electrode 42 on a surface of a substrate 40, after an insulating layer 46 is formed on the transfer substrate to insulate the periphery (edge) of the electrode 42, by the insulating layer forming method of the invention. FIG. 4B is a diagram showing the configuration of a transfer substrate, which has an electrode 42 and an organic low-molecular-weight compound layer 48 sequentially formed on a surface of a substrate 40, after an insulating layer 46 is formed on the transfer substrate to insulate the periphery (edge) of the electrode 42, by the insulating layer forming method of the invention.

### [3] Method of Forming Partition Wall of Electronic Device

A method of forming a partition wall of an electronic device of the invention (hereinafter, also simply referred to as “partition wall forming method”) includes the processes of preparing a transfer material for an electronic device that includes a transfer support and, provided on or above the a transfer support in this order, a partition wall material layer and a layer containing a organic low-molecular-weight compound having charge transportability, and laminating the transfer material on the transfer substrate such that the charge transporting organic compound layer in the transfer material for an electronic device faces a surface of the transfer substrate on which an electrode is provided partially or completely, then heating and pressing, and subsequently removing the transfer support to transfer the partition wall material layer to the surface of the transfer substrate, on which the electrode is provided, thereby forming a partition wall on the transfer substrate.

The partition wall forming method of the invention can be performed in the same manner as the above-described insulating layer forming method of the invention, except that the transfer material for an electronic device (the transfer material of the invention), which has, on or above the transfer support in this, the partition wall material layer and the layer containing the organic low-molecular-weight compound having charge transportability is used as the transfer material for forming the partition wall.

The insulating layer forming method of the invention will now be described with reference to the drawings.

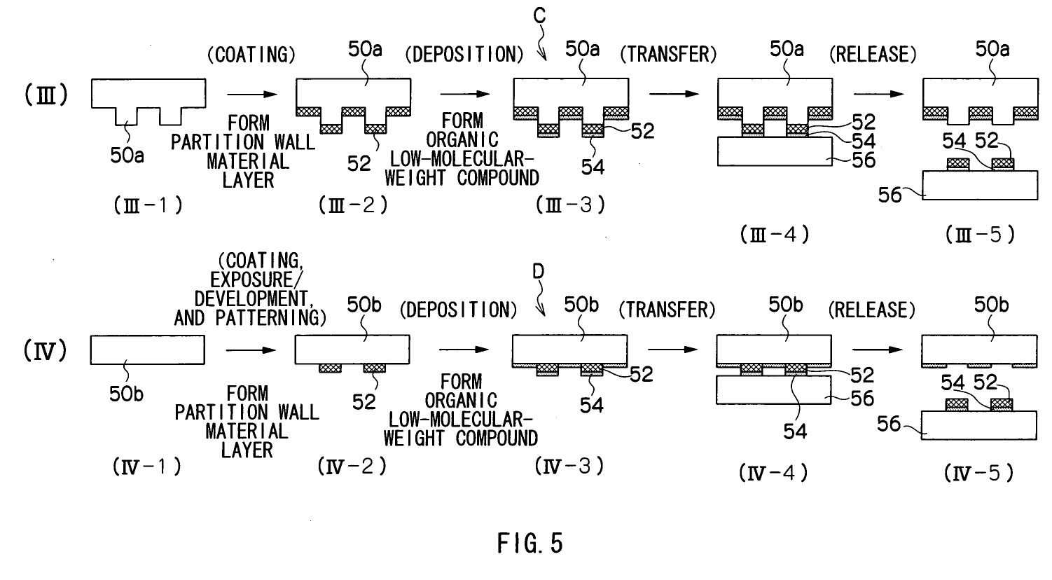

FIG. 5 shows exemplary embodiments of a process flow of forming an insulating layer by the insulating layer forming method of the invention. In FIG. 5, (III) is a process flow showing an exemplary embodiment of forming an insulating layer using a transfer material C, which includes pressing member 50a having a convex portion as a transfer support (hereinafter, referred to as “process flow (III)”).

In the process flow (III), as shown in (III-1) to (III-3), a coating liquid for the partition wall material layer 52 is coated on a surface of the pressing member 50a, on which the convex portion is provided, to thereby form a partition wall material layer 52. Then, an organic low-molecular-weight compound layer 54 is formed on the partition wall material layer 52 by deposition, thereby manufacturing the transfer material C using the pressing member 50a. In addition, as shown in (III-4) to (III-5), the transfer material C is laminated on a transfer substrate 56 such that the organic low-molecular-weight compound layer 54 in the transfer material C faces a surface of the transfer substrate 56, on which an electrode (not shown) is provided, and then heated and/or pressed. Subsequently, the pressing member 50a is removed, and then the partition wall material layer 52 is transferred to the transfer substrate 56 via the organic low-molecular-weight compound layer 54. The transferred partition wall material layer 52 serves as a partition wall in an electronic device, which is manufactured using the transfer substrate 56 after the transfer is completed.

In FIG. 5, (IV) is a flow showing an exemplary embodiment of forming a partition wall using a transfer material D, which has a flat plate-shaped temporary support 50b as a transfer support (hereinafter, referred to as “process flow (IV)”).

In the process flow (IV), as shown in (IV-1) to (IV-3), a coating liquid for the partition wall material layer 52 is coated, developed, and patterned (coating, development, and patterning are not shown), to thereby form the partition wall material layer 52 on the temporary support 50b. Then, an organic low-molecular-weight compound layer 54 is formed on the partition wall material layer 52 by deposition, thereby manufacturing the transfer material D using the temporary support 50b. In addition, as shown in (IV-4) to (IV-5), the transfer material D is laminated on a transfer substrate 56 such that the organic low-molecular-weight compound layer 54 in the transfer material D faces a surface of the transfer substrate 56, on which an electrode (not shown) is provided, and then heated and/or pressed. Subsequently, the temporary support 50b is removed, and then the partition wall material layer 52 is transferred to the transfer substrate 56 via the organic low-molecular-weight compound layer 54. The transferred partition wall material layer 52 serves as a partition wall in an electronic device, which is manufactured using the transfer substrate 56 after the transfer is completed.

For the transfer substrate that are applied to the partition wall forming method of the invention, the same description of the insulating layer forming method of the invention can be applied.

For various conditions that are applied to the partition wall forming method of the invention, the same description of the insulating layer forming method of the invention can be applied.

A preferred exemplary embodiment of the partition wall forming method of the invention includes forming, on the transfer substrate in the invention, an organic compound layer including a light-emitting layer, and then forming a partition wall using the transfer material of the invention.

In an electronic device, such as an organic electroluminescent element, a partition wall has a large thickness. For this reason, if the partition wall is designed before an organic compound layer including a light-emitting layer is formed, for example, when the organic compound layer is provided by a deposition method, a mask may float due to the thickness of the partition wall. Further, even when the organic compound layer is formed by a transfer method, the thickness of the partition wall interferes with the transfer, formation of a fine organic compound layer may not be performed. Particularly, photolithography technology, which requires an etching process, is applied to form the partition wall, a development process or the like needs to be performed, which makes it difficult to form the partition wall after the organic compound layer is formed. In addition, the partition wall, which is formed using the photolithography technology, has poor adhesiveness to the transfer surface.

The partition wall forming method of the invention uses a release and transfer method using the transfer material, which makes it possible to form the partition wall before or after the organic compound layer is formed. Accordingly, the above-described problems do not occur, and formation of a fine organic compound layer can be performed. In addition, a partition wall having high adhesiveness to the transfer surface can be formed.

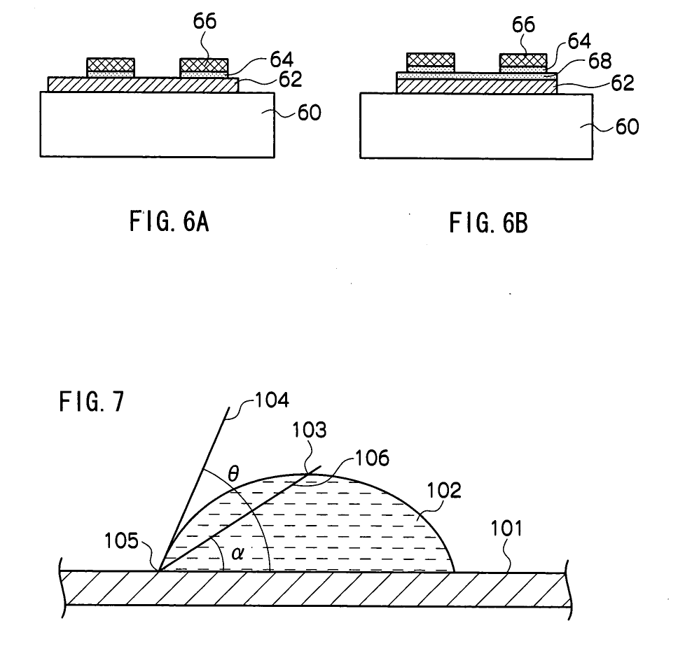

FIGS. 6A and 6B are schematic partial cross-sectional views showing examples of the transfer substrate after a partition wall is formed by the partition wall forming method of the invention. FIG. 6A is a diagram showing the configuration of a transfer substrate, which has an electrode 62 on a surface of a substrate 60, after a partition wall 66 is formed on the transfer substrate by the partition wall forming method of the invention. FIG. 6B is a diagram showing the configuration of a transfer substrate, which has an electrode 62 and an organic low-molecular-weight compound layer 68 on a surface of a substrate 60, after a partition wall 66 is formed on the transfer substrate by the partition wall forming method of the invention.

### [4] Light-Emitting Element

A light-emitting element of the invention has an insulating layer that is formed by the insulating layer forming method of the invention, and/or a partition wall that is formed by the partition wall forming method of the invention. The system, driving method, and application of the light-emitting element of the invention are not particularly limited. As a representative example of the light-emitting element, an organic electroluminescent element can be exemplified. Hereinafter, a description will be given for the light-emitting element of the invention by way of the configuration of the organic electroluminescent element.

### (1) Configuration

The light-emitting element of the invention includes a transparent substrate and, provided on or above the transparent substrate in this order, a transparent electrode layer, at least one organic compound layer, a transparent or nontransparent electrode layer, and a transparent or nontransparent substrate. At least one layer in the organic compound layer is preferably a light-emitting layer. Of these, the light-emitting element of the invention has an insulating layer that is formed by the insulating layer forming method of the invention, and/or a partition wall that is formed by the partition wall forming method of the invention.

The light-emitting element of the invention has the partition wall that is formed by the insulating layer forming method and/or the partition wall forming method of the invention. Therefore, the light-emitting element of the invention exhibits excellent luminescence performance (for example, a reduction in defective pixel luminescence due to short-circuits.

In addition, the overall configuration of the light-emitting element is as follows. The light-emitting element includes, on a substrate, a transparent conductive layer/a light-emitting layer/a rear electrode, a transparent conductive layer/a light-emitting layer/an electron transport layer/a rear electrode, a transparent conductive layer/a hole transport layer/a light-emitting layer/an electron transport layer/a rear electrode, a transparent conductive layer/a hole transport layer/a light-emitting layer/a rear electrode, a transparent conductive layer/a light-emitting layer/an electron transporting organic compound layer/an electron injection layer/a rear electrode, or a transparent conductive layer/a hole injection layer/a hole transport layer/a light-emitting layer/an electron transport layer/an electron injection layer/a rear electrode in that order. In addition, a substrate is provided thereon with an organic compound layer interposed between the substrates. These layers may be laminated inversely. The light-emitting layer contains a fluorescent compound and/or a phosphorescent compound, and luminescence usually comes out from a transparent conductive layer. Specific examples of the compounds used for the individual layers are described, for example, in the extra issue “Organic EL Display” of “Monthly Display” October, 1998 (Techno Times Corp.) or the like.

Hereinafter, the substrate, the electrode, the organic compound layer, and other layers in the light-emitting element will be sequentially described.

### (2) Substrate

Examples of a material for the substrate include inorganic materials, such as yttrium-stabilized zirconia (YSZ) and glass, high-molecular-weight materials, such as polyester or polystyrene (polyethylene terephthalate, polybutylene terephthalate, and polyethylene naphthalate), polycarbonate, polyether sulfone, polyarylate, allyl diglycol carbonate, polyimide, polycycloolefin, norbomene resin, polychlorotrifluoroethylene, Teflon (Registered Trademark), polytetrafluoroethylene, and polyethylene copolymer. The substrate may be formed of a single material or two or more materials. Of these, a high-molecular-weight material is preferably used to form a flexible organic electroluminescent element. Further, polyester, polycarbonate, polyether sulfone, or a high-molecular-weight material containing fluorine atoms, such as polychlorotrifluoroethylene, Teflon (Registered Trademark), or polytetrafluoroethylene-polyethylene copolymer, which is excellent in heat resistance, dimensional stability, solvent resistance, electrical insulation, and workability, and has low aeration and moisture absorption, is preferably used.

The shape, structure, size, and the like of the substrate can be appropriately selected according to the application and the purpose of the light-emitting element. The shape is generally a plate or a successive wafer. The structure may be a monolayer or a laminate. The substrate may be composed of a single member or two or more members. Further, the substrate may be colorless and transparent or colored and transparent. A colorless and transparent substrate is preferably used in that it does not scatter or attenuate light from the light-emitting layer.

An anti-moisture permeation layer (gas barrier layer) may be provided on a surface of the substrate, on which the electrode is formed, an opposite surface to the electrode, or both surfaces. As a material for the anti-moisture permeation layer, an inorganic substance, such as silicon nitride or silicon oxide, is preferably used. The anti-moisture permeation layer can be formed by a high-frequency sputtering method. If necessary, a hard coat layer or an undercoat layer may be provided on the substrate support.

### (3) Electrode

An electrode that serves as an anode to supply holes to the organic compound layer may be used as an anode, and the shape, structure, and size thereof are not particularly limited. An electrode among the general electrodes can be appropriately selected according to the application and the purpose of the light-emitting element.

As a material for the anode include a metal, an alloy, a metal oxide, an organic conductive compound, or a mixture thereof is exemplified. An anode having a work function of 4.0 eV or more is preferably used. Specific examples of the material for the anode include semi-conductive metal oxides, such as tin oxides (ATO and FTO), in which antimony or fluorine is doped, tin oxides, zinc oxides, indium oxides, indium tin oxide (ITO), indium zinc oxide (IZO), metals, such as gold, silver, chromium, and nickel, mixtures or laminates of metals and conductive metal oxides, inorganic conductive materials, such as copper iodide and copper sulfate, disperse substances of the semi-conductive metal oxides or metal compounds, organic conductive materials, such as polyaniline, polythiophene, and polypyrrole, and laminates of these materials and ITO.

The anode can be formed on the substrate by a method selected from wet methods, such as a printing method and a coating method, physical methods, such as a vacuum deposition method, a sputtering method, and an ion plating method, and chemical methods, such as a CVD method and a plasma CVD method, in consideration of applicability to the material for the anode. For example, when ITO is selected as the material for the anode, the formation of the anode can be performed by a direct current or high-frequency sputtering method, a vacuum deposition method, and an ion plating method. Further, when the organic conductive compound is selected as the material for the anode, the formation of the anode can be performed by a wet film deposition method.

Patterning of the anode layer may be performed by chemical etching, such as photolithography, or physical etching, such as laser. Further, patterning may be performed by vacuum deposition or sputtering using a mask, or a lift-off method or a printing method.

The thickness of the anode layer can be appropriately selected according to the material. Generally, the thickness cannot be generally defined, but it is preferably from 10 nm to 50 μm, and more preferably from 50 nm to 20 μm.

The anode preferably has resistance of 10⁶ Ω/sq., or less, and more preferably 10⁵ Ω/sq. or less. When the resistance is 10⁵ Ω/sq. or less, a light-emitting element having excellent performance and a large area can be obtained by providing a bus line electrode.

The anode may be colorless and transparent, colored and transparent, or nontransparent. When the anode is transparent, and luminescence comes out from the transparent anode, transmittance is preferably 60% or more, and more preferably 70% or more. The transmittance can be measured by a known method using a spectrophotometer. As the transparent anode, an electrode that is described in detail in “New Development of Transparent Conductive Film” edited by Y. Sawada (published in 1999 by CMC) can be applied to the invention. Particularly, when a plastic substrate support having low heat resistance is used, it is preferable to use ITO or IZO as a material for a transparent conductive layer, and to form the anode at a low temperature of 150° C. or less.

An electrode that serves as a cathode to inject electrodes into the organic compound layer may be used as a cathode. The shape, structure, and size thereof are not particularly limited. An electrode among the general electrodes can be appropriately selected according to the application and the purpose of the light-emitting element.

As a material for the cathode, a metal simplex, an alloy, a metal oxide, an electrical conducting compound, and a mixture thereof can be exemplified. A cathode having a work function of 4.5 eV or less is preferably used. Specific examples of the material for the cathode include alkali metals (for example, Li, Na, K, and Cs), alkali earth metals (for example, Mg and Ca), gold, silver, lead, aluminum, a sodium-potassium alloy, a lithium-aluminum alloy, a magnesium-silver alloy, indium, and rare-earth metals, such as ytterbium. These may be used alone, but in view of the stability and electron injection property, may be used in combination of two or more.

Of these materials for the cathode, in view of the electron injection property, alkali metals or alkali earth metals are preferably used. Further, in view of preservation stability, a material primarily containing aluminum is preferably used.

Examples of the material primarily containing aluminum include aluminum alone, and alloys or mixtures of aluminum and alkali metals or alkali earth metals of 0.01 to 10% by mass (for example, lithium-aluminum alloy and magnesium-aluminum alloy).

What is necessary is that, when light comes out from the cathode, the transparent cathode is substantially transparent to light (a state where the light amount reaches a required amount during observation). In view of the electron injection property and transparency, the cathode may have a two-layered structure of a thin metal layer and a transparent conductive layer. Moreover, a material for the thin metal layer is described in JP-A Nos. 02-15595 and 05-121172. The thickness of the thin metal layer is preferably from 1 nm to 50 nm. If the thickness is less than 1 nm, it is difficult to uniformly manufacture the thin layer. Further, if the thickness is more than 50 nm, light transmission is deteriorated.

When the cathode has a two-layered structure, a material for the transparent conductive layer is not particularly limited as long as it has conductivity and semi-conductivity and is transparent. The materials that are described for the anode can be appropriately used. Of these, tin oxide (ATO and FTO), in which antimony or fluorine is doped, tin oxide, zinc oxide, indium oxide, indium tin oxide (ITO), and indium zinc oxide (IZO) can be exemplified.

The thickness of the transparent conductive layer is preferably from 30 nm to 500 nm. If the transparent conductive layer is thinner than the range, it has poor conductivity and semi-conductivity. Further, if the thickness is thicker than the range, productivity is deteriorated.

A method of forming the cathode is not particularly limited, but it can be performed using a general method. Preferably, the method is performed in a vacuum apparatus. A physical method, such as a vacuum deposition method, a sputtering method, and an ion plating method, and a chemical method, such as a CVD method and a plasma CVD method, can be exemplified. Of these, one method is preferably selected in consideration of applicability to the material. For example, when a metal or the like is selected as the material for the cathode, one or two or more metals can be deposited simultaneously or sequentially by a sputtering method. Further, when an organic conductive material is used, a wet film deposition method may be used.

Patterning of the cathode may be performed by chemical etching, such as photolithography, or physical etching, such as laser. Further, patterning may be performed by vacuum deposition or sputtering using a mask, or a lift-off method or a printing method.

A dielectric layer may be provided between the cathode and the organic compound layer described below. The dielectric layer is formed of a fluoride of an alkali metal or an alkali earth metal to have a thickness of 0.1 nm to 5 nm. The dielectric layer can be formed by a vacuum deposition method, a sputtering method, or an ion plating method.

### (4) Organic Compound Layer

An organic compound layer is a layer that is interposed between a pair of electrodes in the light-emitting element. The organic compound layer includes a light-emitting layer, an electron transport layer, a hole transport layer, an electron injection layer, a hole injection layer, and the like according to the characteristics. Further, other layers may be provided to improve a chromatic property. Specific examples of the compounds for the individual layers are described, for example, in the extra issue “Organic EL Display” of “Monthly Display” October 1998 (Techno Times Corp.).

The glass transition temperature of the organic compound layer and/or the component of the organic compound layer is preferably from 40° C. to the transfer temperature+40°, more preferably from 50° C. to the transfer temperature+20° C., and further preferably from 60° C. to the transfer temperature. Further, the flow initiation temperature of the organic compound layer of the transfer material and/or the component of the organic compound layer is preferably from 40° C. to the transfer temperature+40° C., more preferably from 50° C. to the transfer temperature+20° C., and further preferably from 60° C. to the transfer temperature. The glass transition temperature can be measured by a differential scanning calorimetry (DSC). Further, the flow initiation temperature can be measured by a flow tester (trade name: CFT-500, manufactured by Shimadzu Corporation) by causing the component to flow from an orifice of an inner diameter 1 mm under a load of 20 Kg/cm² while heating at a predetermined temperature elevation speed.

The formation of the organic compound layer can be formed by a dry film deposition method, such as a release and transfer method, a deposition method, and a sputtering method, a wet film deposition method, such as a spin coating method, a dip coating method, a casting method, a die coating method, a roll coating method, a bar coating method, and a gravure coating method, and a printing method.

(4-a) Light-Emitting Layer

The light-emitting layer contains at least one luminescent compound. The luminescent compound is not particularly limited. A fluorescent compound or a phosphorescent compound may be used. Further, both the fluorescent compound and the phosphorescent compound may be used. In the invention, in view of luminescent luminance and luminescence efficiency, a phosphorescent compound is preferably used.

Examples of the fluorescent compound include benzoxazole derivatives, benzoimidazole derivatives, benzothiazole derivatives, styryl benzene derivatives, polyphenyl derivatives, diphenyl butadiene derivatives, tetraphenyl butadiene derivatives, naphthalimide derivatives, coumalin derivatives, perylene derivatives, perynone derivatives, oxadiazole derivatives, aldazine derivatives, pyraridine derivatives, cyclopentadiene derivatives, bisstyryl anthracene derivatives, quinacridone derivatives, pyrrolopyridine derivatives, thiadiazole pyridine derivatives, styrylamine derivatives, aromatic dimethylidene compounds, metal complexes (metal complexes of 8-quinolinol derivatives and rare-earth complexes), and high-molecular-weight luminescent compounds (polythiophene derivatives, polyphenylene derivatives, polyphenylene vinylene derivatives, and polyfluorene derivatives). These may be used alone or in combination of two or more.

The phosphorescent compound is preferably a compound that can emit light from the triplet excitons. Examples of the phosphorescent compound include ortho-metalated complexes and porphyrin complexes. Of the porphyrin complexes, a porphyrin platinum complex is preferably used. The phosphorescent compounds may be used alone or in combination of two or more.

The ortho-metalated complex used herein is a generic term given to the compounds described, for example, in Yamamoto Akio, “Yukikinzokukagaku-kiso to ohyo”, Shokabo Publishing Co., 1982, p. 150 and 232, and H. Yersin, “Photochemistry and Photophysics of Coordination Compounds”, Springer-Verlag, 1987, p. 71 to 77 and p. 135 to 146. A ligand that forms the ortho-metalated complex is not particularly limited. Examples of the ligand include 2-phenylpyridine derivatives, 7,8-benzoquinoline derivatives, 2-(2-thienyl)pyridine derivatives, 2-(1-naphthyl)pyridine derivatives or 2-phenylquinoline derivatives. The derivatives may have substituents. The ortho-metalated complex may contain other ligands in addition to the ligands forming the ortho-metalated complex. As the center metal of the ortho-metalated complex, any transition metal can be used. In the invention, rhodium, platinum, gold, iridium, ruthenium, and palladium can be preferably used. The organic compound layer containing the ortho-metalated complex is excellent in luminescent luminance and luminescence efficiency. Specific Examples of the ortho-metalated complex are described in Japanese Patent Application No. 2000-254171.

The ortho-metalated complex that can be used in the invention can be synthesized by the known methods described in Inorg. Chem., 30, 1685, 1991, Inorg. Chem., 27, 3464, 1988, Inorg. Chem., 33, 545, 1994, Inorg. Chim. Acta, 181, 245, 1991, J. Organomet. Chem., 335, 293, 1987, J. Am. Chem. Soc., 107, 1431, 1985, and the like.

The content of the luminescent compound in the light-emitting layer is not particularly limited. For example, the content is preferably from 0.1 to 70% by mass, and more preferably from 1 to 20% by mass. If the content of the luminescent compound is less than 0.1% by mass or exceeds 70% by mass, the effect is not sufficiently exhibited.

The light-emitting layer may contain a host compound, a hole transport material, an electron transport material, an electrically inert polymer binder, and the like, if necessary. Moreover, the functions of the materials can be achieved by a single compound. For example, the carbazole derivative functions as the hole transport material as well as the host compound.

The host compound is a compound that causes a luminescent compound to emit light through energy transfer from the excitation state thereof. Specific examples of the host compound include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene compounds, porphyrin compounds, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic acid anhydrides (such as naphthalene and perylene), phthalocyanine derivatives, metal complexes of 8-quinolinol derivatives, metal phthalocyanine, metal complexes having benzoxazole or benzothiazole as a ligand, conductive polymers, such as polysilane compounds, poly(N-vinylcarbazole) derivatives, aniline copolymers, thiophene oligomers, and polythiophene, polythiophene derivatives, polyphenylene derivatives, polyphenylene vinylene derivatives, and polyfluorene derivatives. The host compound may be used alone or in combination of two or more. The content of the host compound in the light-emitting layer is preferably from 0 to 99.9% by mass, and more preferably from 0 to 99.0% by mass.

The hole transport material is not particularly limited as long as it has any one of a function to inject holes from the anode, a function to transport the holes, and a function to block the electrons injected from the cathode. The hole transport material may be a low-molecular weight material or a high-molecular-weight material. Specific examples of the hole transport material include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene compounds, porphyrin compounds, polysilane compounds, poly(N-vinylcarbazole) derivatives, conductive polymers, such as aniline copolymers, thiophene oligomers, and polythiophene, polythiophene derivatives, polyphenylene derivatives, polyphenylene vinylene derivatives, and polyfluorene derivatives. These may be used alone or in combination of two or more. The content of the hole transport material in the light-emitting layer is preferably from 0 to 99.9% by mass, and more preferably 0 to 80.0% by mass.

The electron transport material is not particularly limited as long as it has any one of a function to inject electrons from the cathode, a function to transport the electrons, and a function to block the holes injected from the anode. Specific examples of the electron transport material include triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic acid anhydrides such as naphthalene and perylene, phthalocyanine derivatives, metal complexes of 8-quinolinol derivatives, metal phthalocyanine, metal complexes having benzoxazole or benzothiazole as a ligand, conductive polymers, such as aniline copolymers, thiophene oligomers, and polythiophene, polythiophene derivatives, polyphenylene derivatives, polyphenylene vinylene derivatives, and polyfluorene derivatives. These may be used alone or in combination of two or more. The content of the electron transport material in the light-emitting layer is preferably from 0 to 99.9% by mass, and more preferably from 0 to 80.0% by mass.

Examples of the polymer binder include polyvinyl chloride, polycarbonate, polystyrene, polymethyl methacrylate, polybutyl methacrylate, polyester, polysulfone, polyphenylene oxide, polybutadiene, hydrocarbon resin, ketone resin, phenoxy resin, polyamide, ethyl cellulose, vinyl acetate, ABS resin, polyurethane, melamine resin, unsaturated polyester, alkyd resin, epoxy resin, silicon resin, polyvinyl butyral, and polyvinyl acetal. These may be used alone or in combination of two or more. The light-emitting layer containing the polymer binder can be easily formed to have a large area by a wet film deposition method.

The thickness of the light-emitting layer is preferably from 10 nm to 200 nm, and more preferably 20 nm to 80 nm.

(4-b) Hole Transport Layer

The light-emitting element may have a hole transport layer that is formed of the hole transport material, if necessary. The hole transport layer may contain the polymer binder. The thickness of the hole transport layer is preferably from 10 to 200 nm, and more preferably from 20 nm to 80 nm.

(4-c) Electron Transport Layer

The light-emitting element may have an electron transport layer that is formed of the electron transport material, if necessary. The electron transport layer may contain the polymer binder. The thickness of the electron transport layer is preferably from 10 to 200 nm, and more preferably from 20 nm to 80 nm.

### (5) Other Layers

As other layers of the light-emitting element, a protective layer or a sealing layer is preferably formed in order to prevent deterioration of luminescence performance.

(5-a) Protective Layer

The light-emitting element may have a protective layer described in JP-A Nos. 07-85974, 07-192866, 08-22891, 10-275682, and 10-106746. The protective layer is formed on an uppermost surface of the light-emitting element. Here, the uppermost surface represents an outer surface of the rear electrode when the substrate support, the transparent conductive layer, the organic compound layer, and the rear electrode are laminated in that order. Further, when the substrate support, the rear electrode, the organic compound layer, and the transparent conductive layer are laminated in that order, the protective layer represents an outer surface of the transparent conductive layer. The shape, size, and thickness of the protective layer are not particularly limited. A material for the protective layer is not particularly limited as long as it has a function to suppress moisture or oxygen, which deteriorates the light-emitting element, from entering or permeating the light-emitting element. For example, preferred examples of the material for the protective layer include a silicon monoxide, a silicon dioxide, a germanium monoxide, and a germanium dioxide.

A method of forming the protective layer is not particularly limited. For example, a vacuum deposition method, a sputtering method, a reactive sputtering method, a molecular beam epitaxial method, an ionized cluster beam method, an ion plating method, a plasma polymerization method, a plasma CVD method, a laser CVD method, a thermal CVD method, or a coating method can be applied.

(5-b) Sealing Layer

The light-emitting element preferably has a sealing layer that is provided to prevent moisture or oxygen from entering the element. Examples of a material for the sealing layer include copolymers of tetrafluoroethylene and at least one comonomer, fluorine-containing copolymers having a cyclic structure in the copolymerization main chain, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene or dichlorodifluoroethylene and other comonomers, water-absorbent materials having a water absorption coefficient of 1% or more, moisture-proof materials having a water absorption coefficient of 0.1% or less, metals (In, Sn, Pb, Au, Cu, Ag, Al, Ti, and Ni), metal oxides (MgO, SiO, SiO₂, Al₂O₃, GeO, NiO, CaO, BaO, Fe₂O₃, Y₂O₃, and TiO₂), metal fluorides (MgF₂, LiF, AlF₃, and CaF₂), liquid fluorinated carbon (perfluoroalkane, perfluoroamine, and perfluoroether), and materials obtained by dispersing a moisture or oxygen absorbing agent in liquid fluorinated carbon.

For the purpose of blocking moisture or oxygen from the outside, the organic compound layer is preferably sealed by a sealing member, such as a sealing plate or a sealing container. The sealing member may be provided only on the rear electrode, or may cover the entire light-emitting laminate. The shape, size, and thickness of the sealing member are not particularly limited as long as it can seal the organic compound layer and block external air. Examples of a material for the sealing member include glass, stainless steel, metals (aluminum and the like), plastics (polychlorotrifluoroethylene, polyester, and polycarbonate), ceramics.

When the sealing member is provided on the light-emitting laminate, an appropriate sealant (adhesive) may be used. When the entire light-emitting laminate is covered with the sealing member, the sealing members may be thermally welded, without using any sealant. Examples of the sealant include UV curable resin, thermosetting resin, and two-component curable resin.

A moisture absorbing agent or an inert liquid may be inserted into a space between the sealing container and the light-emitting element. Specific examples of the moisture absorbing agent include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, and magnesium oxide. Examples of the inert liquid include paraffins, liquid paraffins, fluorine solvents (perfluoroalkane, perfluoroamine, and perfluoroether), chlorine solvents, and silicon oils.

The light-emitting element can emit light when a DC voltage (which is usually from 2 to 40 Volts and may include an AC component, if necessary) or a DC current is applied between the anode and the cathode.

For driving the light-emitting element of the invention, the methods described in JP-A Nos. 02-148689, 06-301355, 05-29080, 07-134558, 08-234685 and 08-241047, U.S. Pat. Nos. 5,828,429 and 6,023,308, Japanese Patent No. 2784615 can be used.

According to the invention, it is possible to provide a transfer material for an electronic device that can simply form an insulating layer or a partition wall having high adhesiveness to a surface to be transferred, and a method of forming an insulating layer and a partition wall of an electronic device using the transfer material. Further, according to the invention, it is possible to provide a light-emitting element having excellent luminescent performance that is obtained using a transfer material for an electronic device, which can simply form an insulating layer or a partition wall having high adhesiveness to a surface to be transferred.

### EXAMPLES

Hereinafter, the present invention will be described in detail by way of examples. Although a description will be given below by way of an organic electroluminescent element as an electronic device, an electronic device, to which the invention is applied, is not limited thereto.

### Example 1

### 1. Manufacturing of Transfer Material

### 1-1. Manufacturing of Transfer Support

A pressing member (hereinafter, referred to as “transfer support A”) that included a convex portion (Rₘₐₓ=0.5 nm) having 100 μm width and 150 μm pitch on one surface and was formed of quartz glass having a thickness of 0.7 mm was prepared. Then, one surface of the pressing member A was immersed in a solution containing a fluorine surface antifouling coating agent (trade name: OPTOOL DSX, 0.1 wt % diluted solution of Demnum Solvent, manufactured by Daikin Industries, Ltd.) for one minute, taken out from the solution, and dried. After drying, a transfer support A having a release layer A of thickness 10 nm was obtained.

### Contact Angle Measurement

For the transfer support A having the release layer A, a contact angle of a surface having the release layer A with respect to pure water was measured by a contact angle meter type DROPMASTER 300 manufactured by Kyowa Interface Science Co., Ltd. and the contact angle was 114°. The measurement was performed for 10 seconds at a temperature 24° C. and relative humidity 50% after dropping.

### Surface Roughness Measurement

An area of 20000 nm×20000 nm was sampled for every 0.05 nm in a lattice shape, and the maximum surface roughness Rmax of a surface having the release layer A in the transfer support A was measured by an atomic force microscopy method using SPI-3800N SPA-400, manufactured by Seiko Instruments, Inc. according to JIS B 0601-1982. The content of JIS B 0601-1982 is incorporated by reference herein.

### 1-2. Manufacturing of Transfer Material A1 and Transfer Material A2

### Transfer Material A1

A positive photosensitive resin (trade name: TFR-H, manufactured by Tokyo Ohka Kogyo Co., Ltd.) was coated on the resultant transfer support A having the release layer A by spin coating to have a thickness of 1000 nm after drying, to thereby form an insulating layer, and exposure was performed. Next, Alq₃ (the structure described below) was deposited as an organic low-molecular-weight compound layer to have a thickness of 20 nm using a small vacuum deposition apparatus (trade name: VPC-410A, manufactured by Ulvac Kiko Inc.). The expression Rₘₐₓ/organic layer×100=2.5% was established. In such a manner, the transfer material A1 having an insulating layer was obtained.

### Transfer Material A2

A photoresist (trade name: ZPN-1100, manufactured by Zeon Japan Corporation) was coated on the resultant transfer support A having the release layer A by spin coating to have a thickness of 3000 nm after drying, to thereby form a partition wall material layer, and exposure was performed. Next, Alq₃ (the structure described below) was deposited as an organic low-molecular-weight compound layer to have a thickness of 20 nm using a small vacuum deposition apparatus (trade name: VPC-410A, manufactured by Ulvac Kiko Inc.). In such a manner, the transfer material A1 having a partition wall material layer was obtained.

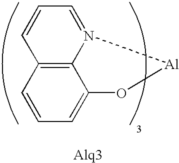

### 2. Manufacturing of Organic Electroluminescent Element (1)

### 2-1. Transfer Substrate (Anode and Organic Compound Layer Formation)

White plate glass of 0.5 mm×2.5 cm×2.5 cm was prepared and introduced in a vacuum chamber. Then, DC magnetron sputtering (condition: substrate temperature is 250° C. and oxygen pressure is 1×10⁻³ Pa) was performed using an ITO target (indium:tin=95:5 (molar ratio)) having 10% by mass SnO₂, to thereby form a transparent electrode (anode) formed of an ITO thin film having a thickness of 100 nm. Surface resistance of the ITO thin film was 10 Ω/sq. Subsequently, an etching treatment was performed by a photolithography method to pattern the transparent electrode layer (ITO film). The glass plate, on which the transparent electrode (ITO) was formed, was put in a cleaning container and cleaned by isopropyl alcohol (IPA). Then, a UV-ozonation treatment was performed for 30 minutes. Copper phthalocyanine was provided on the surface of the processed transparent electrode to have a thickness of 10 nm as a hole injection layer by a vacuum deposition method at a speed of 1 nm/second. N,N′-dinaphthyl-N,N′-diphenylbenzidine (NPD) as a hole transport material was formed on the hole injection layer to have a thickness of 50 nm by a vacuum deposition method at a speed of 1 nm/second, to thereby form a hole transport layer. Next, tris(2-phenylpyridyl)iridium complex as an ortho-metalated complex which is a phosphorescent material, and 4,4′-N,N′-dicarbazolebiphenyl as a host material were deposited together on the hole transport layer by a vacuum deposition method at speeds of 0.1 nm/second and 1 nm/second, respectively, to thereby form a light-emitting layer having a thickness of 40 nm. Next, the above described Alq₃ (tris(8-hydroxyquinolinato)aluminum) as an electron transport material was deposited on the light-emitting layer by a vacuum deposition method at a speed of 1 nm/second, to thereby form an electron transport layer having a thickness of 40 nm.

### 2-2. Insulating Layer Formation by Transfer

The transfer substrate, on which the anode and the organic compound layer (hole injection layer, hole transport layer, light-emitting layer, and electron transport layer) were provided, and the transfer material A1 were arranged such that the organic compound layers overlapped each other, and pressed at a pressure of 0.3 MPa. Then, they passed between a pair of rollers (heating rollers at 90° C.) at a speed of 0.1 m/minute, and thus heating and pressing were performed simultaneously. Next, the transfer material A1 was removed, and an insulating layer was formed on the uppermost surface of the substrate/anode/organic compound layer (hole injection layer, hole transport layer, light-emitting layer, and electron transport layer)/organic low-molecular-weight compound layer (electron transport layer) to overlap an edge of the anode by 30 μm width.

### 2-3. Partition Wall Formation by Transfer

The substrate, on which the anode and the organic compound layer (hole injection layer, hole transport layer, light-emitting layer, electron transport layer)/organic low-molecular-weight compound layer (electron transport layer)/insulating layer were formed, and the transfer material A2 were arranged such that the organic compound layers overlapped each other, and pressed at a pressure of 0.3 MPa. Then, they passed between a pair of rollers (heating rollers at 70° C.) at a speed of 0.1 m/minute, and heating and pressing were performed simultaneously. Next, the transfer material A2 was removed, and the partition wall was formed on the uppermost surface of the substrate/anode/organic compound layer (hole injection layer, hole transport layer, light-emitting layer, and electron transport layer)/organic low-molecular-weight compound layer (electron transport layer)/insulating layer.

### 2-4. Cathode Formation

Lithium fluoride was deposited on the upper surface of the substrate/anode/organic compound layer (hole injection layer, hole transport layer, light-emitting layer, and electron transport layer)/organic low-molecular-weight compound layer (electron transporting organic thin film layer)/insulating layer/partition wall by a vacuum deposition method, to thereby form an electron injection layer having a thickness of 1 nm. Aluminum was deposited on the electron injection layer by a vacuum deposition method, to thereby form a cathode having a thickness of 150 nm. Aluminum leads were connected to the anode and the cathode, respectively.

### 2-5. Sealing

The resultant was put in a glove box under a substituted argon gas atmosphere, and sealed using a stainless steel sealing can and a UV curable adhesive (trade name: XNR-5516-HV, manufactured by Nagase ChemteX Corp.).

In such a manner, an organic electroluminescent element (1) as an organic electroluminescent element of the example was obtained.

### 3. Evaluation

For the transfer materials A1 and A2 manufactured in the above-described manner, transferability and adhesiveness were evaluated. Further, the luminescent performance of the organic electroluminescent element (1) was evaluated. The evaluation methods and criteria are as follows. The results are shown in Table 1.

### 3-1. Adhesiveness

The adhesiveness was evaluated by observing a release state of a transfer layer (insulating layer or partition wall) after a cross-cut adhesion test was performed according to JIS D 0202-1988.

### Evaluation Criteria

A: Class 4B or more (release area of less than 5%)

B: Class 3B (release area of 5 to 15%)

C: Class 2B or less

### 3-2. Transfer Property

The transferability was evaluated by measuring an area of 10 mm² of the transfer materials A1 and A2 using a three-dimensional surface roughness meter (trade name: LT-8010, manufactured by Keyence Corp.) and determining whether or not the structure obtained corresponds with the original design.

### Evaluation Criteria

A: Good

B: A transfer layer (insulating layer or partition wall) is formed, but irregularity in thickness or defects exist.

C: No transfer

### 3-3. Luminescent Performance

The luminescent performance was evaluated according to how many areas out of 50 areas of 100 μm² were luminescent.

### Evaluation Criteria

A: 90% or more (45 or more)

B: 70% or more (35 or more)

C: less than 70% (less than 35)

### Example 2

A transfer material B1 having an insulating layer and a transfer material B2 having an insulating layer were manufactured in the same manner as Example 1, except that, in the transfer material A1 and the transfer material A2 manufactured in Example 1, the organic low-molecular-weight compound layer (20 nm) formed of Alq₃ was replaced with an organic low-molecular-weight compound layer (20 nm) formed of NPD (the structure described below). In addition, an organic electroluminescent element (2) was manufactured using the transfer material B1 and the transfer material B2 in the same manner as Example 1.

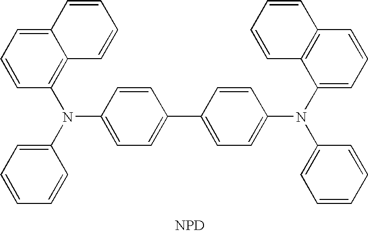

For the resultant transfer materials B1 and B2, and the organic electroluminescent element (2), the evaluation was performed in the same manner as Example 1. The evaluation result is shown in Table 1.

### Example 3

A transfer material C1 having an insulating layer and a transfer material C2 having a partition wall material layer were manufactured in the same manner as Example 2, except that, while the release layer A was formed on the transfer support A in Example 2, a transfer support A only subjected to cleaning was used. In addition, an organic electroluminescent element (3) was manufactured using the transfer material C1 and the transfer material C2 in the same manner as Example 2.

The contact angle with respect to pure water at the surface of the transfer support A, and the surface roughness were measured in the same manner as Example 1. As a result, the contact angle was 30°, and the maximum surface roughness Rmax was 0.5 nm. The expression R_{max/}organic layer×100=2.5% was established.

For the resultant transfer material C1, transfer material C2, and organic electroluminescent element (3), the evaluation was performed in the same manner as Example 1. The evaluation result is shown in Table 1.

### Example 4

A transfer material D1 having an insulating layer and a transfer material D2 having a partition wall material layer were manufactured in the same manner as Example 2, excluding the following difference. That is, in Example 4, instead of the transfer support A having the release layer A in Example 2, a pressing member (hereinafter, referred to as “transfer support B”) that was formed of a stainless steel plate having a thickness of 1 mm having a convex portion (Rmax=20 nm) of 100 μm width and 150 μm pitch on one surface was used. Then, a coating liquid for the release layer B having the composition described below was coated and dried on one surface of the transfer support B, to thereby form the release layer B having a thickness of 3 μm after drying. In addition, an organic electroluminescent element (4) was manufactured in the same manner as Example 2 using the transfer material D1 and the transfer material D2.

### Coating Liquid for Release Layer B

polyester resin (trade name: HP-320, glass transition temperature 62° C. and softening point 95° C., manufactured by Nippon Synthetic Industry Co., Ltd.): 30 parts by mass

silicon-modified acryl resin solution (trade name: US-3700, manufactured by Toagosei Co., Ltd.): 10 parts by mass

methyl ethyl ketone: 30 parts by mass

toluene: 30 parts by mass

The contact angle of the surface having the release layer B in the transfer support B with respect to pure water, and the maximum surface roughness Rₘₐₓ were measured in the same manner as Example 1. As a result, the contact angle was 98°, and the maximum surface roughness Rₘₐₓ was 3 nm. The expression Rₘₐₓ/organic layer×100=2.5% established.

For the resultant transfer material D1, transfer material D2, and organic electroluminescent element (4), the evaluation was performed in the same manner as Example 1. The evaluation result is shown in Table 1.

### Example 5

A transfer material E1 having an insulating layer and a transfer material E2 having a partition wall material layer were manufactured in the same manner as Example 4, except that, a transfer support B only subjected to cleaning was used, without forming the release layer B on the transfer support B. In addition, an organic electroluminescent element (5) was manufactured in the same manner as Example 4 using the transfer material E1 and the transfer material E2.

The contact angle with respect to pure water at the surface of the transfer support B, and the maximum surface roughness Rₘₐₓ were measured in the same manner as Example 1. As a result, the contact angle was 42°, and the maximum surface roughness Rₘₐₓ was 30 nm. The expression Rₘₐₓ/organic layer×100=150% was established.

For the resultant transfer material E1, transfer material E2, and organic electroluminescent element (5), the evaluation was performed in the same manner as Example 1. The evaluation result is shown in Table 1.

### Example 6

A transfer material F1 having an insulating layer and a transfer material F2 having a partition wall material layer were manufactured in the same manner as Example 2, excluding the following difference. That is, in Example 2, instead of the transfer support A having the release layer A, a pressing member (hereinafter, referred to as “transfer support C”) that was formed of quartz glass having a thickness of 0.7 mm and Rₘₐₓ=0.5 nm was used. Then a coating liquid for the release layer B was coated and dried on one surface of the transfer support C, to thereby form a release layer B having a thickness of 3 μm after drying. In addition, an organic electroluminescent element (6) was manufactured in the same manner as Example 2 using the transfer material F1 and the transfer material F2.

The contact angle of the surface having the release layer B in the transfer support C with respect to pure water, and the maximum surface roughness Rₘₐₓ were measured in the same manner as Example 1. As a result, the contact angle was 98°, and the maximum surface roughness Rₘₐₓ was 3 nm. The expression Rₘₐₓ/organic layer×100=15% was established.

For the resultant transfer material F1, transfer material F2, and organic electroluminescent element (6), the evaluation was performed in the same manner as Example 1. The evaluation result is shown in Table 1.

### Example 7

A transfer material G1 having an insulating layer and a transfer material G2 having a partition wall material layer were manufactured in the same manner as Example 1, excluding the following difference. That is, in Example 1, instead of the transfer support A having the release layer A, a temporary support (hereinafter, referred to as “transfer support D”) that was formed of polyethylene terephthalate (trade name: Lumirror T-60, manufactured by Toray Industries Inc.) having a thickness of 0.1 mm and Rₘₐₓ=40 nm was used. Then, a coating liquid for the release layer B was coated and dried on one surface of the transport support D, to thereby form the release layer B having a thickness of 3 μm after drying. Further, for forming the insulating layer and the partition wall, PTPDEK (trade name, 3 wt % diluted by a dichloroethane solvent, manufactured by Chemipro Kasei Kaisha, Ltd.). was coated by spin coating to have a thickness after drying according to the insulating layer and the partition wall. In addition, an organic electroluminescent element (7) was manufactured in the same manner as Example 1 using the transfer material G1 and the transfer material G2.

The contact angle of the surface having the release layer B in the transfer support D with respect to pure water, and the maximum surface roughness Rₘₐₓ were measured in the same manner as Example 1. As a result, the contact angle was 98°, and the maximum surface roughness Rₘₐₓ was 3 nm. Further, the expression Rₘₐₓ/organic layer×100=15% was established.

For the resultant transfer material G1, transfer material G2, and organic electroluminescent element (7), the evaluation was performed in the same manner as Example 1. The evaluation result is shown in Table 1.

### Comparative Example 1

A transfer material H1 having an insulating layer and a transfer material H2 having a partition wall material layer were manufactured in the same manner as Example 1, except that an organic low-molecular-weight compound layer was not formed. In addition, an organic electroluminescent element (8) of Comparative Example was manufactured in the same manner as Example 1 using transfer material H1 and the transfer material H2.

For the resultant transfer material H1, transfer material H2, and organic electroluminescent element (8), the evaluation was performed in the same manner as Example 1. The evaluation result is shown in Table 1.

### Comparative Example 2

A transfer material I1 having an insulating layer and a transfer material I2 having a partition wall material layer were manufactured in the same manner as Example 4, except that an organic low-molecular-weight compound layer was not formed. In addition, an organic electroluminescent element (9) of Comparative Example was manufactured in the same manner as Example 4 using the transfer material I1 and the transfer material I2.

For the resultant transfer material I1, transfer material I2, and organic electroluminescent element (9), the evaluation was performed in the same manner as Example 1. The evaluation result is shown in Table 1.

### Comparative Example 3

A transfer material J1 having an insulating layer and a transfer material J2 having a partition wall material layer were manufactured in the same manner as Example 6, except that, in manufacturing the transfer material, a transfer support C only subjected to cleaning was used, without forming a release layer B formed on the transfer support C, unlike Example 6, and an organic low-molecular-weight compound layer was not formed. In addition, an organic electroluminescent element (10) was manufactured in the same manner as Example 6 using the transfer material J1 and the transfer material J2.

The contact angle with respect to pure water at the surface of the transfer support C and the maximum surface roughness Rₘₐₓ were measured in the same manner as Example 1. As a result, the contact angle was 42°, and the maximum surface roughness Rₘₐₓ was 30 nm. The expression Rₘₐₓ/organic layer×100=150% was established.

For the resultant transfer material J1, transfer material J2, and organic electroluminescent element (10), the evaluation was performed in the same manner as Example 1. The evaluation result is shown in Table 1.

### Comparative Example 4

A transfer material K1 having an insulating layer and a transfer material K2 having a partition wall material layer were manufactured in the same manner as Example 7, excluding that an organic low-molecular-weight compound layer was not formed in manufacturing the transfer material, unlike Example 7. In addition, an organic electroluminescent element (11) of Comparative Example 4 was manufactured in the same manner as Example 1 using the transfer material K1 and the transfer material K2.

For the resultant transfer material K1, transfer material K2, the organic electroluminescent element (11), the evaluation was performed in the same manner as Example 1. The evaluation is shown in Table 1.

TABLE 1

| | | Transfer Material | | | | | | | | | |
|---|---|---|---|---|---|---|---|---|---|---|---|
| | | | | Insulating | | | | | | | |
| | | | | Material | | Organic | | | | | |
| | Organic | | | or | | Low- | | | Evaluation | | |
| | electrolu- | | | Partition | | Molecular- | | | Adhe- | Transfer | |
| | minescent | | Transfer | Wall | | Weight | Contact | | sive- | Prop- | Luminescent |
| | element | Type | Support | Material | Release Layer | Compound | Angle | Rₘₐₓ | ness | erty | Performance |
| Example 1 | (1) | Transfer | Transfer | TFR-H | Release Layer A | Alq₃ 20 nm | 114° | 0.5 nm | A | A | A |
| | | material A1 | Support A | | | | | | | | |
| | | Transfer | | ZPN-1100 | | | | | | | |
| | | material A2 | | | | | | | | | |
| Example 2 | (2) | Transfer | Transfer | TFR-H | Release Layer A | NPD 20 nm | 114° | 0.5 nm | A | A | A |
| | | material B1 | Support A | | | | | | | | |
| | | Transfer | | ZPN-1100 | | | | | | | |
| | | material B2 | | | | | | | | | |
| Example 3 | (3) | Transfer | Transfer | TFR-H | — | NPD 20 nm | 30° | 0.5 nm | A | B | B |
| | | material C1 | Support A | | | | | | | | |
| | | Transfer | | ZPN-1100 | | | | | | | |
| | | material C2 | | | | | | | | | |
| Example 4 | (4) | Transfer | Transfer | TFR-H | Release Layer B | NPD 20 nm | 98° | 3 nm | A | A | A |
| | | material D1 | Support B | | | | | | | | |
| | | Transfer | | ZPN-1100 | | | | | | | |
| | | material D2 | | | | | | | | | |
| Example 5 | (5) | Transfer | Transfer | TFR-H | — | NPD 20 nm | 42° | 30 nm | B | B | B |
| | | material E1 | Support B | | | | | | | | |
| | | Transfer | | ZPN-1100 | | | | | | | |
| | | material E2 | | | | | | | | | |
| Example 6 | (6) | Transfer | Transfer | TFR-H | Release Layer B | NPD 20 nm | 98° | 3 nm | A | A | A |
| | | material F1 | Support C | | | | | | | | |
| | | Transfer | | ZPN-1100 | | | | | | | |
| | | material F2 | | | | | | | | | |
| Example 7 | (7) | Transfer | Transfer | PTPDEK | Release Layer B | Alq₃ 20 nm | 98° | 3 nm | A | A | A |
| | | material G1 | Support D | | | | | | | | |
| | | Transfer | | PTPDEK | | | | | | | |
| | | material G2 | | | | | | | | | |
| Comparative | (8) | Transfer | Transfer | TFR-H | Release Layer A | — | 114° | 0.5 nm | C | A | A |
| Example 1 | | material H1 | Support A | | | | | | | | |
| | | Transfer | | ZPN-1100 | | | | | | | |
| | | material H2 | | | | | | | | | |
| Comparative | (9) | Transfer | Transfer | TFR-H | Release Layer B | — | 98° | 3 nm | C | A | A |
| Example 2 | | material I1 | Support B | | | | | | | | |
| | | Transfer | | ZPN-1100 | | | | | | | |
| | | material I2 | | | | | | | | | |
| Comparative | (10) | Transfer | Transfer | TFR-H | — | — | 42° | 30 nm | C | B | B |
| Example 3 | | material J1 | Support C | | | | | | | | |
| | | Transfer | | ZPN-1100 | | | | | | | |
| | | material J2 | | | | | | | | | |
| Comparative | (11) | Transfer | Transfer | PTPDEK | Release Layer B | — | 98° | 3 nm | C | A | A |
| Example 4 | | material K1 | Support D | | | | | | | | |
| | | Transfer | | | | | | | | | |
| | | material K2 | | | | | | | | | |

As shown in Table 1, it can be seen that the individual transfer materials obtained by Examples are excellent in transfer property and adhesiveness, and the organic electroluminescent elements of Examples that are obtained using the transfer materials are elements having excellent luminescent performance. Meanwhile, the individual transfer materials obtained by Comparative Examples, which do not have an organic low-molecular-weight compound layer, had poor adhesiveness.

All publications, patent applications, and technical standards mentioned in this specification are herein incorporated by reference to the same extent as if each individual publication, patent application, or technical standard was specifically and individually indicated to be incorporated by reference.

What is claimed is:

1. A transfer material for an electronic device comprising:
a transfer support and, provided on or above the support in this order,
an insulating layer or a partition wall material layer, and
a layer containing an organic low-molecular-weight compound having charge transportability.

2. The transfer material for an electronic device of claim 1,
wherein a surface of the transfer support, on which the insulating layer or the partition wall material layer is formed, has a contact angle of 50° or more with respect to pure water.

3. The transfer material for an electronic device of claim 1,
wherein maximum surface roughness Rₘₐₓ of a surface of the transfer support, on which the insulating layer or the partition wall material layer is formed, is in a range of 0 to 50 when the thickness of the layer containing the organic low-molecular-weight compound having charge transportability is set at 100.

4. The transfer material for an electronic device of claim 1,
wherein the organic low-molecular-weight compound having charge transportability is a compound selected from the group consisting of triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic acid anhydrides, phthalocyanine derivatives, 8-quinolinol derivatives, metallophthalocyanine, metal complexes having benzoxazole as a ligand, metal complexes having benzothiazole as a ligand, aniline copolymers, thiophene oligomers, polythiophene, polythiophene derivatives, polyphenylene derivatives, polyphenylene vinylene derivatives, and polyfluorene derivatives.

5. The transfer material for an electronic device of claim 1,
wherein the thickness of the layer containing the organic low-molecular-weight compound having charge transportability is 1 nm or more.

6. The transfer material for an electronic device of claim 1,
wherein the layer containing the organic low-molecular-weight compound having charge transportability is formed by a method selected from the group consisting of a vacuum deposition method, a sputtering method, a reactive sputtering method, a molecular beam epitaxial method, an ionized cluster beam method, an ion plating method, a plasma polymerization method, a plasma CVD method, a laser CVD method, a thermal CVD method, and a coating method.

7. The transfer material for an electronic device of claim 1, further comprising:
a release layer that is formed between the transfer support, and the insulating layer or the partition wall material layer.

8. A method of forming an insulating layer of an electronic device, the method comprising:
preparing a transfer material for an electronic device that includes a transfer support and, provided on or above the transfer support in this order, an insulating layer and a layer containing an organic low-molecular-weight compound having charge transportability; and
laminating the transfer material on a transfer substrate such that the layer containing the organic low-molecular-weight compound having charge transportability in the transfer material for an electronic device faces a surface of the transfer substrate on which an electrode is provided partially or entirely, then heating and pressing, and subsequently removing the transfer support to transfer the insulating layer to the surface of the transfer substrate on which the electrode is provided, thereby forming an insulating layer on the transfer substrate.

9. A method of forming a partition wall of an electronic device, the method comprising:
preparing a transfer material for an electronic device that includes a transfer support and, provided on or above the transfer support in this order, a partition wall material layer and a layer containing an organic low-molecular-weight compound having charge transportability; and
laminating the transfer material on a transfer substrate such that the layer containing the organic low-molecular-weight compound having charge transportability in the transfer material for an electronic device faces a surface of the transfer substrate on which an electrode is provided partially or entirely, then heating and pressing, and subsequently removing the transfer support to transfer the partition wall material layer to the surface of the transfer substrate on which the electrode is provided, thereby forming a partition wall on the transfer substrate.

10. The method of forming a partition wall of an electronic device of claim 9,
wherein, after an organic compound layer including a light-emitting layer is formed on the transfer substrate, a partition wall is formed using the transfer material for an electronic device.

11. A light-emitting element comprising an insulating layer that is formed using the method of claim 8.

12. A light-emitting element comprising a partition wall that is formed using the method of claim 9.

13. A light-emitting element comprising a partition wall that is formed using the method of claim 10.
